(19) United States
(12) Patent Application Publication
(10) Pub. No.: US 2016/0148515 A1
(43) Pub. Date: May 26, 2016

(54) WEB AND MOBILE PARENT ENGAGEMENT AND LEARNING MANAGEMENT SYSTEM

(71) Applicant: MyChild, Inc., Chicago, IL (US)

(72) Inventors: Hugo Augusto, Chicago, IL (US); Mauro Boneco, Chicago, IL (US); Joao Barata, Chicago, IL (US)

(21) Appl. No.: 14/945,312

(22) Filed: Nov. 18, 2015

Related U.S. Application Data
(60) Provisional application No. 62/082,564, filed on Nov. 20, 2014.

(51) Int. Cl. G09B 5/00; G06F 3/0481; G06F 3/0482; G06F 17/30

(52) U.S. Cl. CPC G09B 5/00; G06F 17/3053; G06F 17/30867; G06F 3/04817; G06F 3/0482

(57) ABSTRACT

Systems and methods are provided for assisting with education development (e.g., early educational development), including web and mobile-based status reports and daily diaries of activities, analytics on the progress of a student toward educational goals, and/or application recommendations to reinforce and/or assist in achieving educational development goals. Additional content to reinforce educational development is recommended by accessing a plurality of images with each of the plurality of images associated with a tag. A number of tags for the images are aggregated and a development score is generated based on the aggregated number of tags and a predetermined threshold. The development score is compared to an application profile data structure of an application and an application relevance score is generated based on the comparison. An application identifier of an application can be selected based on the application relevance score and transmitted to a client device to link to the application.

### BACKGROUND

For education systems, typically tracking or logging of student or child activities is performed manually by a teacher or educational professional. Such tracking or logging usually includes the teacher or educational professional recording a grade, receiving projects, writing a summary of activities, and/or other logging or tracking of the student's or child's activities. The teacher or educational professional may keep track of grades, projects, etc. in a written log book or ledger to keep track of each student or child's progress over time. However, such systems require large amounts of paperwork and large commitments of time to maintain and manage the paperwork. Moreover, such a system provides limited accessibility to parents and/or administrators for tracking and/or monitoring the progress of a student or child. For instance, parents may be limited to parent-teacher conferences, report cards, or other time-delayed periodic updates. Administrators may also be limited to periodic updates and/or may incur large time costs to scour through written records and/or track activities to a curriculum to monitor a teacher's work and/or the progress of a class.

### SUMMARY

Implementations described herein relate to systems and methods for assisting with education development (e.g., early educational development), including web and mobile-based status reports and daily diaries of activities, analytics on the progress of a student toward educational goals, and/or application recommendations to reinforce and/or assist in achieving the educational development goals.

One implementation relates to a method for recommending additional content to reinforce educational development. The method includes accessing a set of images. Each of the images is associated with a tag. The method includes aggregating a number of tags for the set of images, and generating a development score using the aggregated number of tags and a predetermined threshold. The method also includes comparing the development score to an application profile data structure of an application, and generating an application relevance score based on the comparison of the development score to the application profile data structure. The method further includes selecting an application identifier of the application based on the application relevance score, and transmitting the application identifier for the application to a client device to link to the application.

In some implementations, the client device is redirected to an installation file for the application responsive to a selection of a displayed icon for the application identifier. The application may be an early education application and the development score may be a development score for an early education goal. In some implementations, the client device is redirected to a third-party application store landing page for the installation file. In some instances, the client device is redirected to an installed application on the client device responsive to a selection of a displayed icon for the application identifier. In some instances, generating the application relevance score is further based on a recommendation value. In some implementations, selecting the application identifier of the application based on the application relevance score includes comparing the application relevance score to an application score threshold value, and selecting the application identifier responsive to the application relevance score exceeding the application score threshold value. In some instances, the method may further include receiving a request for recommended applications from an interface displayed on the client device and transmitting the application identifier for the application responsive to the request for recommended applications. The client device can display an interface with an icon for the application based on the transmitted application identifier, and the icon redirects the client device to link to the application upon a selection.

Another implementation relates to a system that includes one or more processors and one or more storage devices. The one or more storage devices includes instructions that cause the one or more processors to perform several operations. The operations include accessing a first set of images associated with a first tag and a second set of images associated with a second tag. The operations also includes aggregating a first number of first tags for the first set of images and a second number of second tags for the second set of images. The operations further include generating a first development score using the aggregated first number of first tags and a first predetermined threshold, and generating a second development score using the aggregated second number of second tags and a second predetermined threshold. The operations still further include generating a progress report based on the first development score and the second development score, and transmitting the progress report to a client device to be displayed in an interface.

In some implementations, the first tag and second tag are based on an educational goal. In some instances, the progress report includes a graphical chart. In some instances, generating the first development score is based on a linear algorithm for the first predetermined threshold. In some implementations, the operations further include receiving an image associated with the first tag of the first set of images from a second client device, wherein the client device is a parent device and the second client device is an educator device. In some implementations, the operations further include generating an aggregate development score based on the aggregated first number of first tags, the first predetermined threshold, the aggregated second number of second tags, and a second predetermined threshold.

Yet a further implementation relates to a computer readable storage device storing instructions that, when executed by one or more processors, cause the one or more processors to perform several operations. The operations include accessing a set of aggregated tags, each of the set of tags associated with an educational development category. The operations include generating a set of development scores using the set of aggregated tags and a set of predetermined thresholds. The operations further include comparing the set of development scores to a first application profile data structure of a first application, and generating a first application relevance score based on the comparison of the set of development scores to the first application profile data structure. The operations also include comparing the set of development scores to a second application profile data structure of a second application, and generating a second application relevance score based on the comparison of the set of development scores to the second application profile data structure. The operations still further include ranking the first application and the second application based on the first application relevance score and the second application relevance score, and transmitting data indicative of a ranked order for the first application and the second application to a client device for display in an interface displayed on a display of the client device.

In some implementations, the transmitted data indicative of the ranked order includes a first application identifier for the first application and a second application identifier for the second application. In some instances, the client device is redirected to an installation file for the first application responsive to a selection of a displayed icon for the first application identifier. The first application may be an early education application and the development scores may be for early education goals. The client device may be redirected to a third-party application store landing page for the installation file. In some other instances, the client device is redirected to an installed application on the client device responsive to a selection of a displayed icon for the first application identifier. In some implementations, generating the first application relevance score is further based on a recommendation value.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is an overview depicting an implementation of a system for a web and/or mobile based system for parent engagement and learning management;

FIG. 2 is a process diagram for a teacher device to log or record activities of a student or child and to upload to a back-end server;

FIGS. 3-5 are overviews demonstrating aspects of the system displayable on a teacher device for generating a new entry;

FIG. 6 is a process diagram for a back-end server to receive the generated new entries from one or more teacher devices and to store data records based on the generated new entries;

FIG. 7 is a process diagram for a back-end server to receive a request for a data record and to retrieve and transmit the data record to the parent device responsive to the request;

FIG. 8 is a process diagram for a back-end server to receive a request for a report, generate the report using a report generation system, and transmit the report to the parent device responsive to the request;

FIG. 9 is a process diagram for a back-end server to receive a request for analytics data, generate the analytics data using a data analytics system, and transmit the generated analytics data to the parent device responsive to the request;

FIG. 10 is a process diagram for a parent device to log into a service to access and/or interact with the back-end server, transmit a request for one or more data records, a report, and/or analytics data, and display the one or more data records, report, and/or analytics data;

FIGS. 11-13 are overviews depicting generated reports displayable on a parent device responsive to a request for a report;

FIG. 14 is an overview demonstrating aspects of the system displayable on display of a parent device for specifying a goal and/or sub-goal for requesting one or more data records from the back-end server;

FIGS. 15-16 are overviews demonstrating aspects of the system displayable on display of a parent device for one or more data records received from the back-end server responsive to a request;

FIGS. 17-18 are overviews demonstrating aspects of the system displayable on display of a parent device for selecting one or more third-party sharing systems for transmitting data for one or more data records, reports, and/or analytics data received from the back-end server;

FIGS. 19-22 are overviews demonstrating aspects of the system displayable on display of a parent device for analytics data received from the back-end server responsive to a request;

FIG. 23 is a process diagram for an administrator device and/or teacher device to log into a service to access and/or interact with the back-end server, transmit a request for one or more data records, a report, and/or analytics data, and display the one or more data records, report, and/or analytics data;

FIG. 24 is a process diagram for an administrator device to log into a service to access and/or interact with the back-end server and to modify configuration data, curriculum data, and/or application data;

FIG. 25 is a process diagram for a teacher device to log into a service to access and/or interact with the back-end server and to modify curriculum data and/or application data;

FIG. 26 is an overview demonstrating aspects of the system displayable on display of a teacher device or administrator device for modifying curriculum data;

FIGS. 27-29 is an overview demonstrating aspects of the system displayable on display of a parent device, administrator device, and/or teacher device for selecting and/or modifying one or more applications associated with a goal or sub-goal of a curriculum;

FIG. 30 is a process diagram for recommending additional content to reinforce educational development; and

FIG. 31 is a block diagram depicting a general architecture for a computer system that may be employed to implement various elements of the systems and methods described and illustrated herein.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Following below are more detailed descriptions of various concepts related to, and implementations of methods, apparatuses, and systems for web and/or mobile based systems for parent engagement and learning management. The various concepts introduced above and discussed in greater detail below may be implemented in any of numerous ways as the described concepts are not limited to any particular manner of implementation. Examples of specific implementations and applications are provided primarily for illustrative purposes.

A parent engagement and learning management system may assist child care centers, preschools, schools, and/or other educational facilities to reduce reliance on paper methods of tracking progress, potentially becoming entirely paperless. Moreover, such a parent engagement and learning management system enables real-time updating of data records for students or children during activities or soon thereafter. Teachers or other education professionals may quickly register classroom, group, and/or specific student or child activities by generating a new entry on a device operable by the teacher. Such a new entry may identify a goal and/or sub-goal from a curriculum (e.g., Common Core State Standards, the Head Start Child Development, Early Learning Framework, and/or any other curriculum) that is associated with the activity, identify one or more student or children for which the new entry is to be associated, and/or include additional data concerning the activity documented in the new entry, such as a time, a place, one or more photos or videos, one or more documents (e.g., assignments), a score or other valuation (e.g., mood, status, etc.), one or more tags, any notes, and/or any other additional data concerning the activity documented in the new entry. The new entry may then be transmitted to a back-end server from which one or more data records based on the new entry may be generated and stored in a record database.

The records in the record database may be accessible by administrators or directors of the child care center, preschool, school, and/or other educational facility such that the administrator or director can review the data records. In some implementations, the administrators or directors may also approve or deny the data record before the data record is accessible to one or more parents accessing data records via the back-end server, such was via a web interface or a mobile application interface. In some implementations, the administrators or directors may view aggregate reports and/or analytics data generated by the back-end server for the data records stored in the record database. Such a system may increase the efficiency for both the administrators or directors and/or the system itself by reducing the number of requests for data records received and acted upon by the back-end server. For instance, an aggregate report and/or aggregate analytics data for the entirety of the education facility may be generated using a repot generation system and/or data analytics system of the back-end server that permits administrators or directors to, at a glance and substantially in real-time, view the performance of the educational facility in meeting curriculum goals and/or sub-goals. Moreover, administrators or directors may be able to generate reports and/or analytics data for specific teachers or other education professionals, classes, groups, and/or particular students, thereby offering a single system to oversee and monitor progress across a variety of filtered levels. Moreover, the parent engagement and learning management system helps administrators or directors to increase parent engagement, improve student or child retention, and save time and costs. For instance, an administrator or director may receive notifications when a particular student, child, group, or class is not meeting goals and/or sub-goals of a curriculum. The administrator or director then may act on such information by notifying parents and/or working with a teacher or other educational professional to meet the goal and/or sub-goal.

Such a parent engagement and learning management system includes features such as a classroom, student, or child diary and/or data record notes that can improve the focus on learning by sharing learning concepts and daily activities tagged with curriculum objectives that can foster a dialogue between parent and a student or child or engage parents based on updates on their student's or child's unique learning and development, provide progress reports that may include daily notes, assessments of class and/or child statistics, and/or child portfolios to measure the impact of activities on the progress towards meeting goals and/or sub-goals of a curriculum, provide sharing features to permit parents to share data records, reports, and/or portions thereof via third-party sharing systems, sharing of calendar data for upcoming planned activities or events, transmit emails concerning data records and/or reports to parents, provide reminders, newsletters, and/or announcements in a compact and efficient manner to parents, and/or provide access to relevant forms, documents, and/or applications.

Such a parent engagement and learning management system provides teachers, educational professionals, and/or administrators tools for planning, documentation, ongoing assessment and reporting, thereby enabling teachers and educational professionals to focus on student or child development and allowing administrators efficient review and assessment of such student or child development.

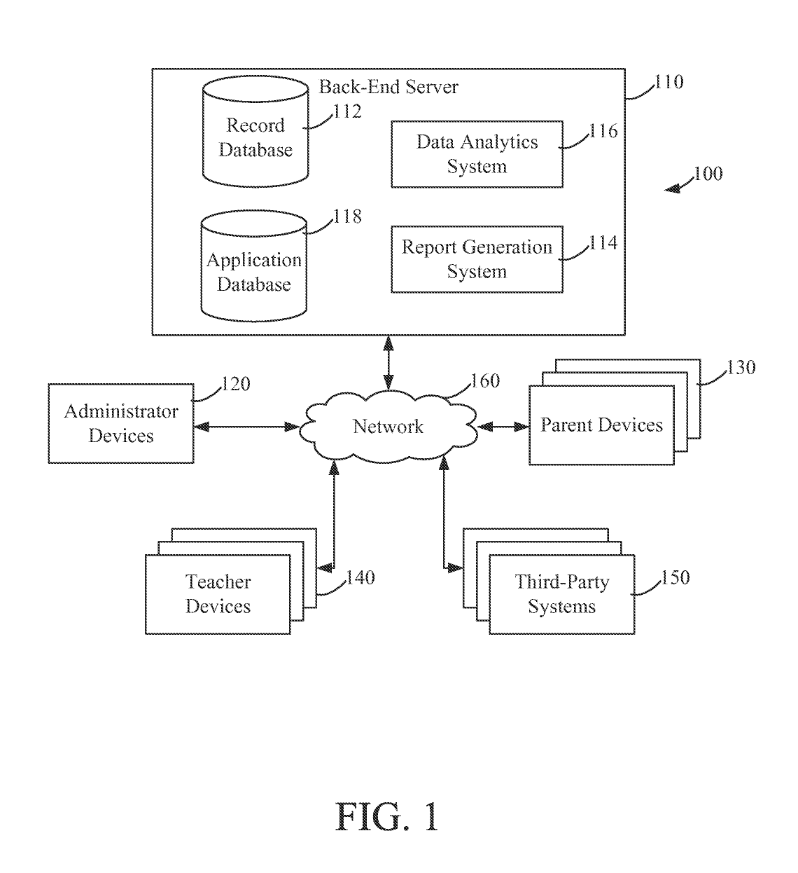

FIG. 1 depicts a system 100 having a back-end server 110, one or more administrator devices 120, one or more parent devices 130, one or more teacher devices 140, and, in some implementations, one or more third-party systems 150. The back-end server 110, one or more administrator devices 120, one or more parent devices 130, one or more teacher devices 140, and one or more third-party systems 150 may communicate via a network 160. The network 160 may include a local area network (LAN), wide area network (WAN), a telephone network, such as the Public Switched Telephone Network (PSTN), a wireless link, an intranet, the Internet, or combinations thereof.

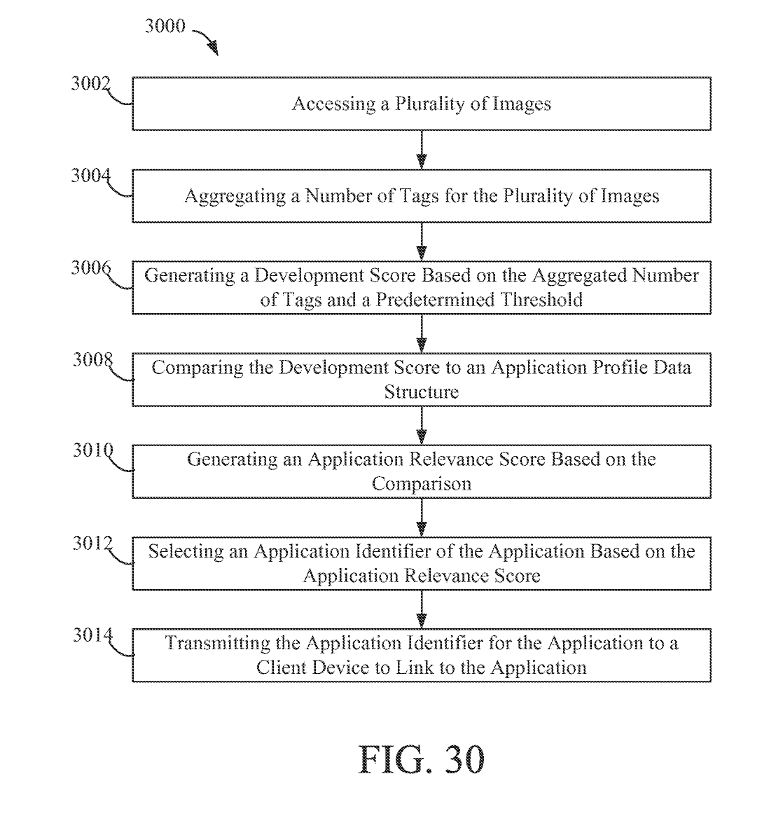

The system 100 includes one or more teacher devices 140 operable by a teacher or educational professional to log or record activities of a student or child as they occur and/or soon thereafter. Such a teacher device 140, which may be a computing device as described in reference to FIG. 30, may include a display that can display a user interface to allow the teacher generate a new entry to be transmitted to the back-end server 110. The interface may allow the teacher to take and associate photos and/or videos with the new entry, type and/or write notes for the new entry, select one or more students or children to which the new entry corresponds, select one or more goals from a curriculum to be associated with the new entry, enter a score or other valuation as part of the new entry, and/or enter other data for the new entry.

The system 100 also includes a back-end server 110 that receives new entries from the one or more teacher devices 140 operable by the teacher or educational professional, generates one or more data records based on the new entry, and stores the generated one or more data records in a record database 112. The back-end server 110 may also be a computing device as described in reference to FIG. 30. In some implementations, the generated data records may be sorted and stored based on identifiers associated with a particular student or child, identifiers associated with a particular group, class, grade, or school, identifiers associated with a particular teacher, identifiers associated with a particular goal or sub-goal of a curriculum, etc. In some implementations, the data records for a particular student or child may be encrypted or otherwise secured such that access to the data record is only permitted by authorized users.

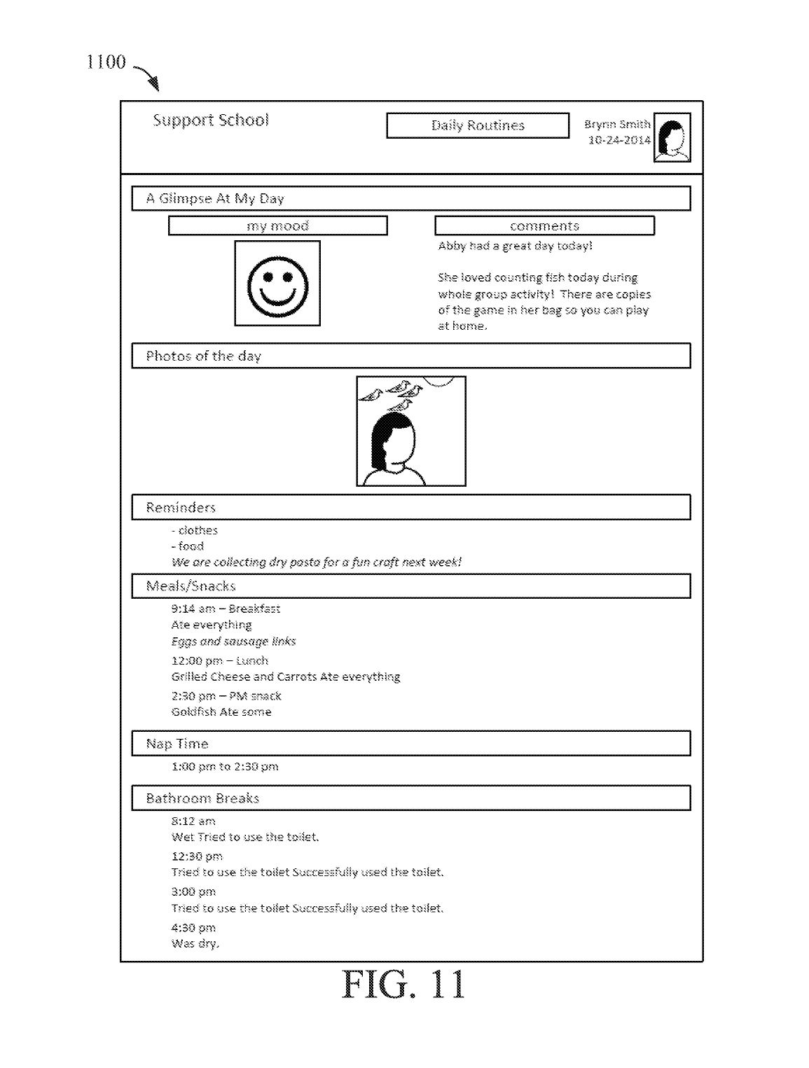

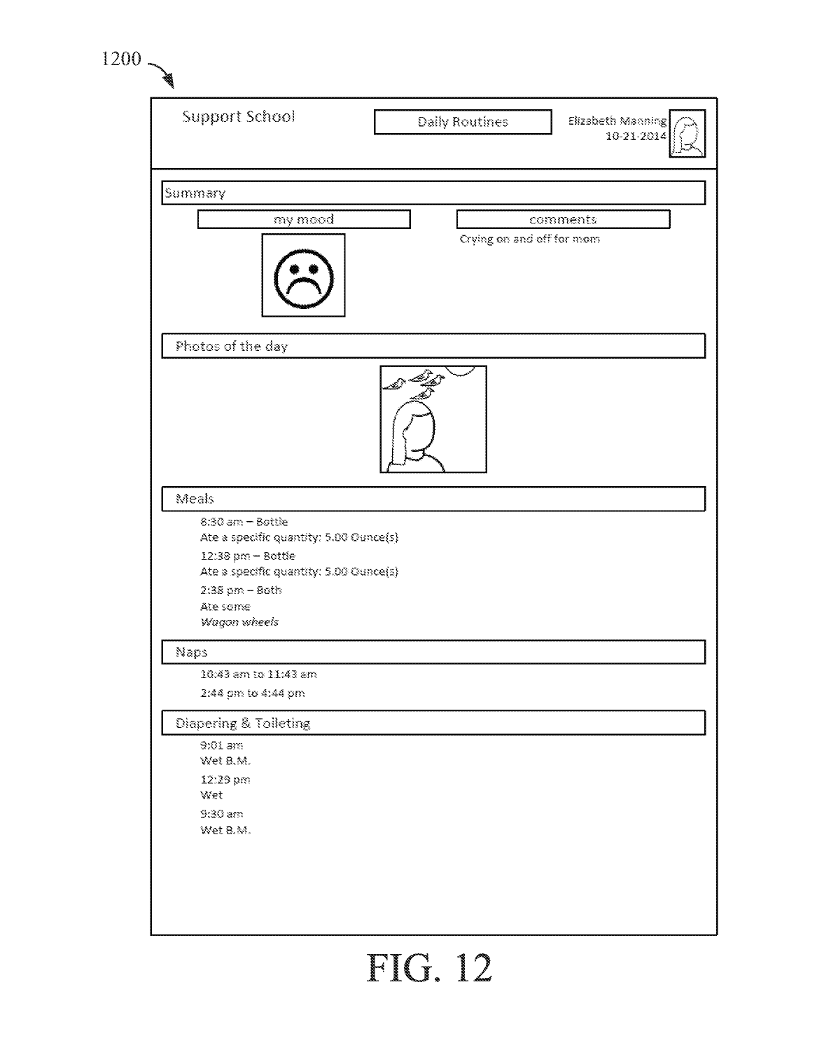

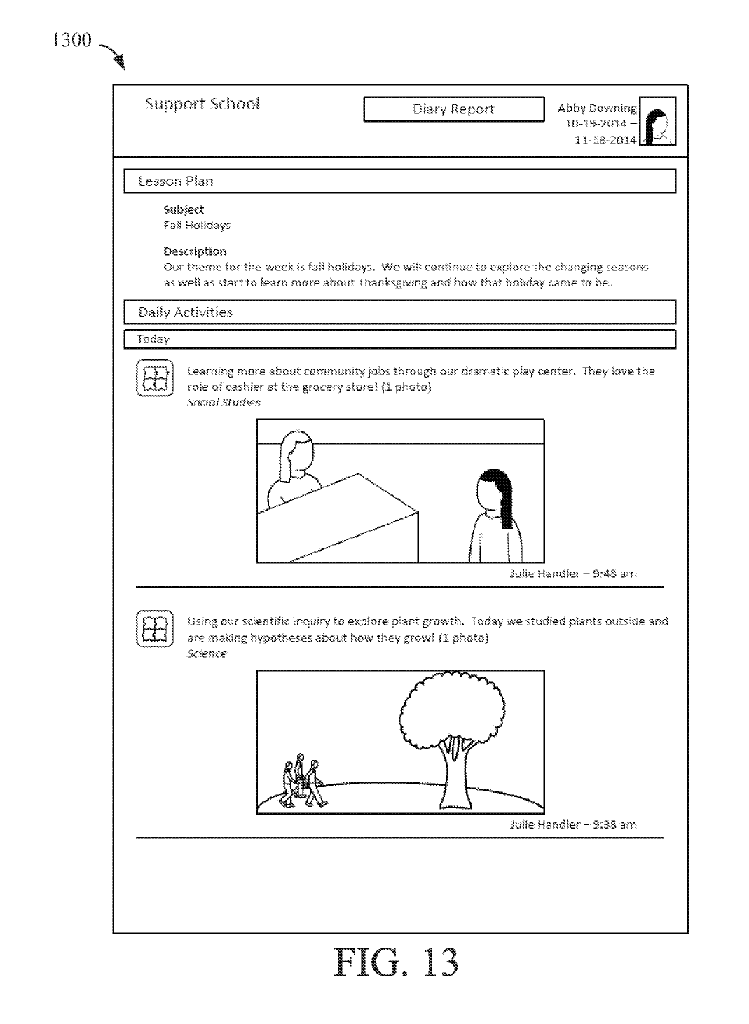

In some implementations, the back-end server 110 may include a report generation system 114 configured to generate a report, such as those depicted in FIGS. 11-13. The report generation system 114 may be configured to retrieve one or more data records from the record database 112 and to generate reports. The report generation system 114 may generate reports for a particular student or child based on the data records associated with the particular student or child, for a particular group, class, grade, or school based on the data records associated with the particular group, class, grade, or school, for a particular teacher based on the data records associated with the particular teacher, etc. In some implementations, the report generation system 114 may incorporate analytics data and/or display data for displaying graphical or other visual representations of the analytics data from a data analytics system 116.

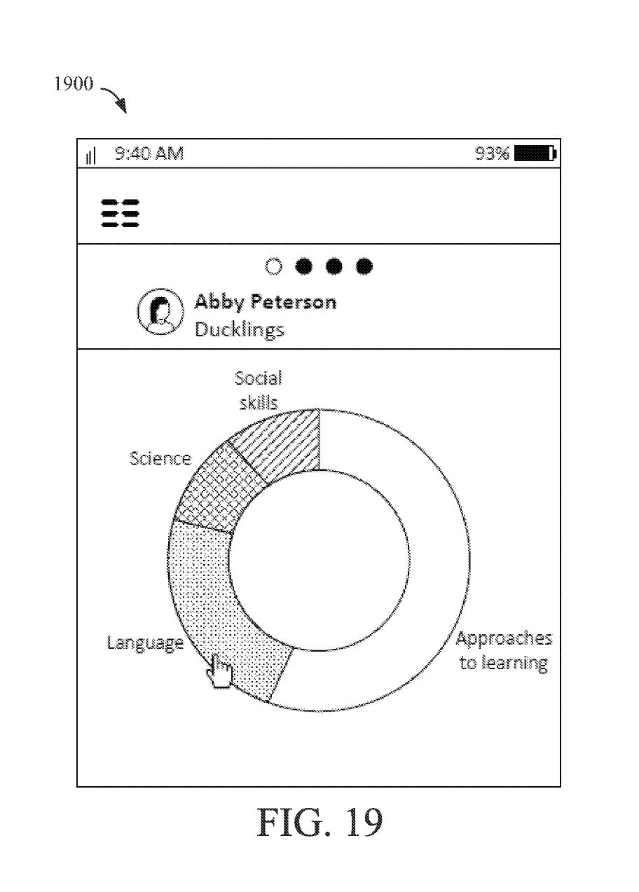

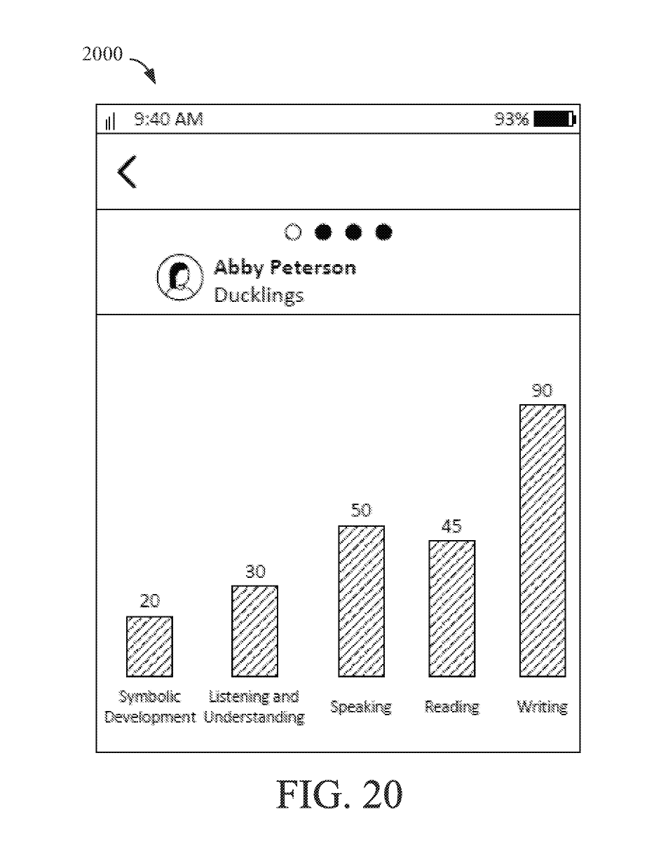

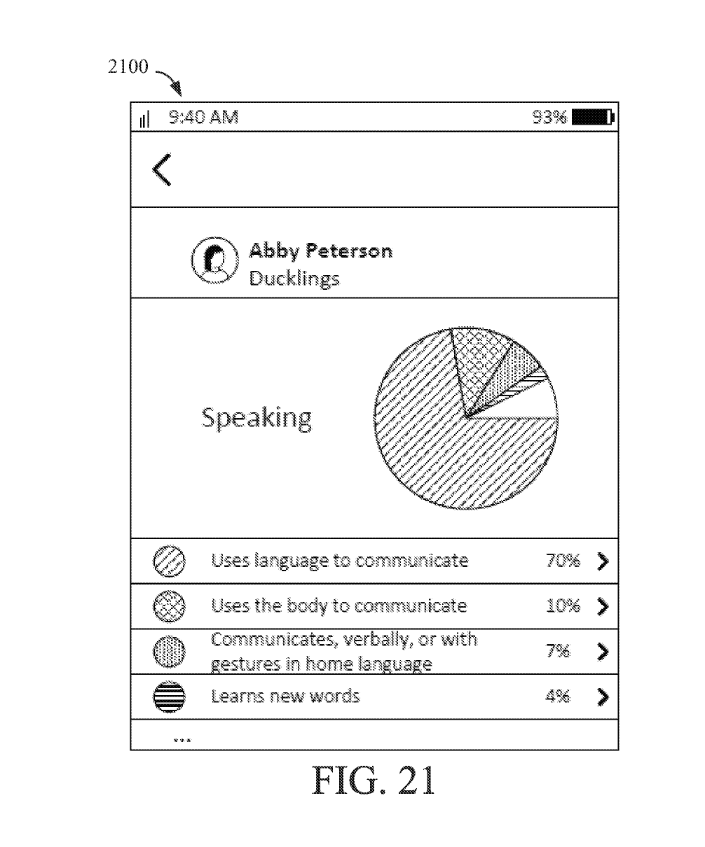

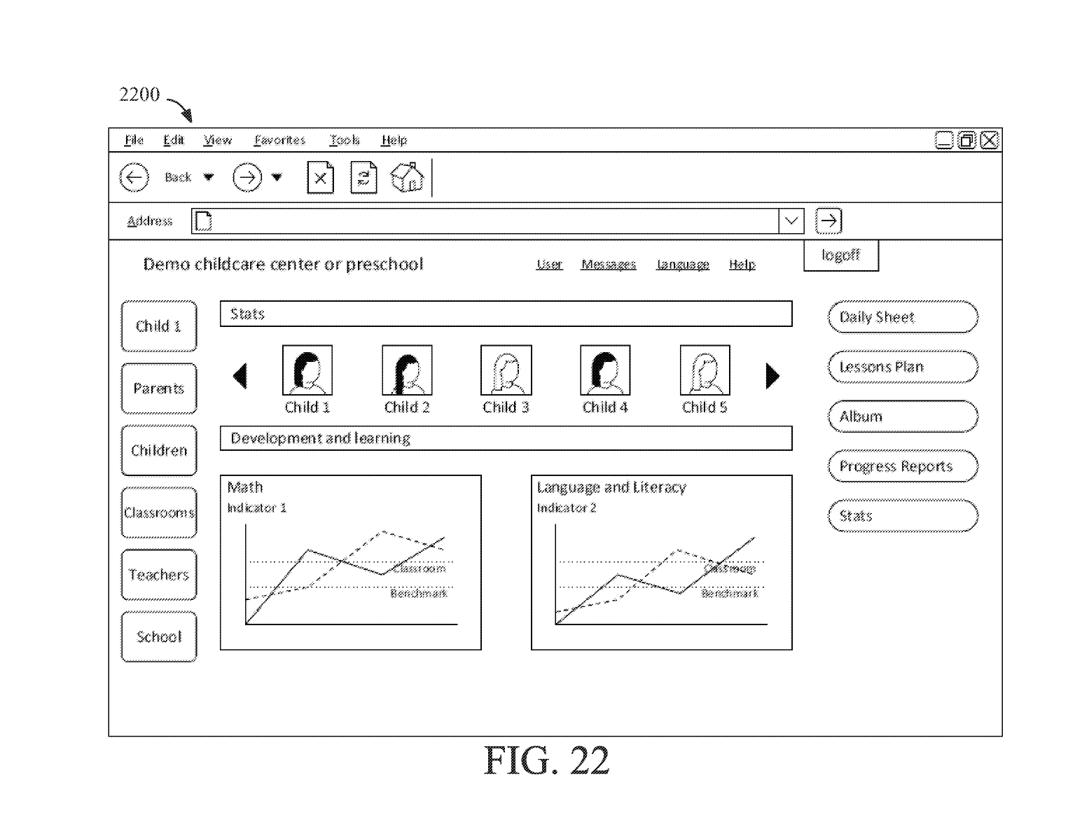

The back-end server 110 may include a data analytics system 116 that is configured to generate analytics data based on the data records. For instance, the data analytics system 116 may be configured to retrieve one or more data records from the record database 112 and to generate the analytics data, such as a percentage of goals and/or sub-goals completed for a specified curriculum. The analytics data may be generated for particular students or children, for a particular group, class, grade, or school, for a particular teacher, etc. In some implementations, the data analytics system 116 may generate display data for displaying graphical or other visual representations of the analytics data (e.g., pie graphs, bar graphs, line graphs, area graphs, proportional geometric shape graphs (e.g., doughnut, bubble, radar), etc.), such as those depicted in FIGS. 19-22.

In some implementations, the data analytics system 116 can access a set of images that include one or more tags. For instance, an image from a data record of the record database 112 may be tagged by a teacher or other educator with a corresponding educational goal tag (e.g., writing, reading, speaking, listening and understanding, symbolic development, etc.) and/or educational development category tag (e.g., mathematics, language arts, science, etc.). In some instances, the image may have several associated tags. The data analytics system 116 can aggregate the tags into a number of tags for the images. For instance, if ten images are tagged with the educational development category tag of “science,” then the aggregated number for the “science” tag is ten. Based on the aggregated number of tags, the data analytics system 116 can generate a development score using a predetermined threshold. For instance, if the predetermined threshold is twenty (i.e., corresponding to having an educational goal of twenty science events and/or experiences), then the development score can be calculated out as 50% based on the ten aggregated tags and the predetermined threshold of twenty. In some implementations, the predetermined threshold may be based on a curriculum for the student, class, school, etc. In other implementations, more complex algorithms for the development score may be implemented (e.g., having the development score be based on a weighted value for the aggregated tags, having the development score be based on a multi-variable weighted function of several aggregated tags, etc.). As will be discussed in greater detail herein, the development score may be used for generating progress reports and/or for recommending one or more applications. In some implementations, an aggregate development score may be calculated from one or more development scores and/or directly from aggregated numbers of tags and the predetermined threshold values. In some implementations, the data analytics system 116 can directly access the plurality of tags without accessing the images.

The back-end server 110 may still further include, in some implementations, an application database 118. The application database 118 may store application data that may be accessed via one or more devices interacting with the back-end server 110 (e.g., one or more teacher devices 140, one or more administrator devices 120, one or more parent devices 130, etc.) and/or the application database 118 may include a data structure that includes links to the application data. The application database 118 may include application identifiers for each application of the application database. In some implementations, the links to the application data may be links to a third-party system 150, such as an application serving system and/or an application hosting system. The applications and/or links to applications may managed by one or more devices interacting with the back-end server 110, such as the one or more administrator devices 120 and/or one or more teacher devices 140.

The system 100 may further include one or more administrator devices 120 operable by an administrator to access and/or modify the data records of the back-end server 110, modify a curriculum stored on the back-end server 110, modify the applications and/or links stored in the application database 118, etc. The one or more administrator devices 120 may include an interface that allows the administrator to retrieve a report generated by the report generation system 114, view, modify, and/or approve of one or more data records, view analytics data generated by the data analytics system 116, modify the configuration data of the back-end server 110, modify curriculum data, modify the applications and/or links stored in the application database 118, and/or perform other administrative tasks for the system 110.

The system 100 includes one or more parent devices 130 operable by a parent or other authorized user to access the data records of the back-end server 110 for a particular student or child and/or otherwise interact with the back-end server 110. The one or more parent devices 130 may include an interface that allows the parent or authorized user to request and view a report generated by the report generation system 114 for a particular student or child, request and view one or more data records for a particular student or child, request and view analytics data generated by the data analytics system 116 for a particular student or child, share one or more data records via interaction with one or more third-party systems, integrate calendar data with a calendar on the one or more parent devices, receive notifications from the back-end database (such as based on additional stored data records transmitted to the back-end database for a particular student or child or the addition of calendar events to a calendar of the back-end server), access one or more applications associated with a goal or sub-goal of a curriculum, and/or interact with the back-end server 110 in other manners for a particular student or child.

One or more third-party systems 150 may be in communication with one or more of the one or more parent devices 130, one or more administrator devices 120, one or more teacher devices 140, and/or the back-end server 110. In some implementations, the one or more third-party systems may be host a third-party application store with one or more landing pages linking to one or more installation files for applications.

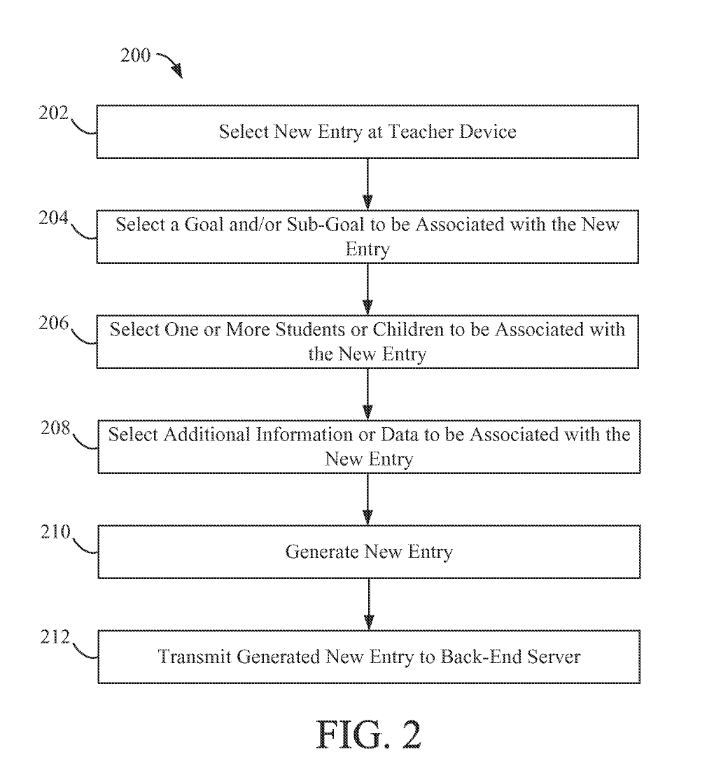

FIG. 2 depicts a process 200 that may be executed via the one or more teacher devices 140 of FIG. 1. In some implementations, an application may execute and/or web interface may be used on the one or more teacher devices 140 that includes a user interface for a user, such as a teacher, to input data for the process 200. The process 200 may include selecting a new entry at the teacher device (block 202). The selection of a create new entry selection feature of the user interface may be used to initially generate the new record entry. The teacher device 140 may then generate a new entry file and store an initial new entry data file in a data store, e.g., memory, of the teacher device 140.

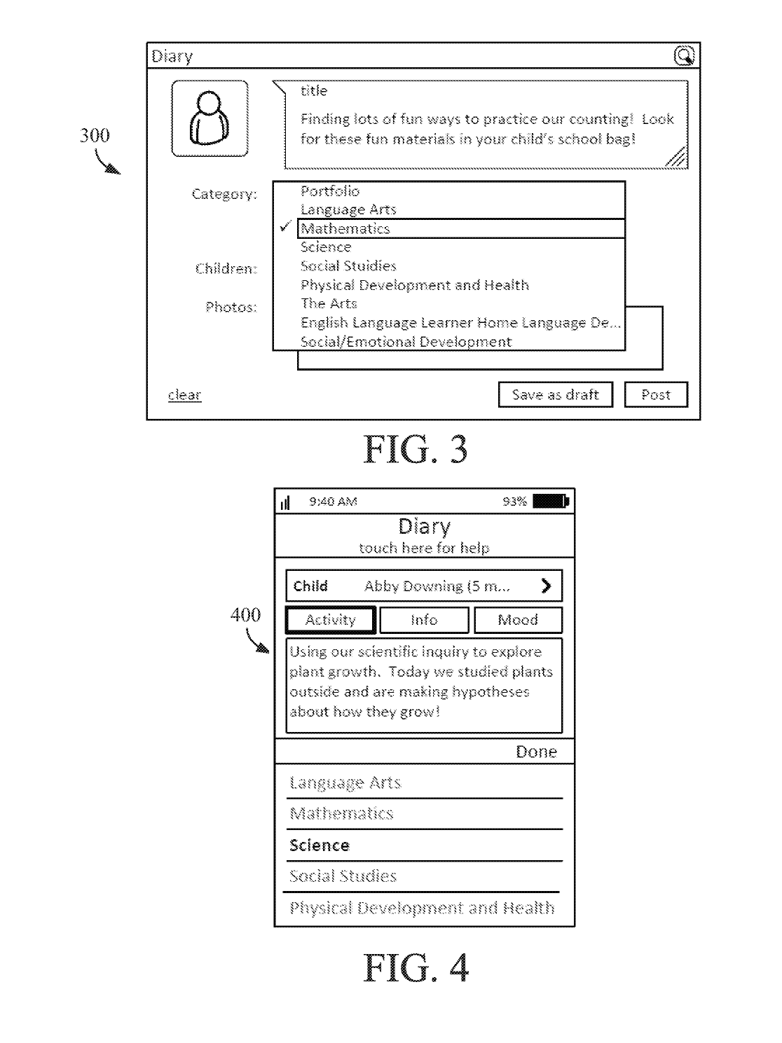

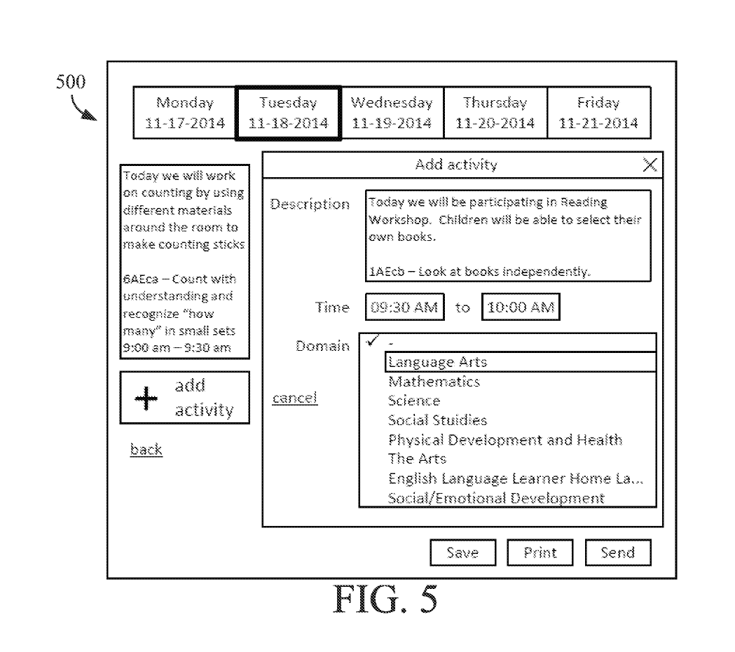

The process 200 includes the selection of a goal and/or sub-goal to be associated with the new entry (block 204). The goal and/or sub-goal may be based on curriculum data, such as curriculum data stored at the back-end server 110 and associated with the particular teacher using the teacher device 140, a particular class, a particular student or child, etc. In some instances, the curriculum data may correspond to a standardized curriculum, such as Common Core State Standards, the Head Start Child Development, Early Learning Framework, state-specific curriculums, and/or any other curriculum. The selection of the goal and/or sub-goal may be done through a selection feature of the user interface, such as a drop-down menu (e.g., as shown in FIG. 3 or 5 demonstrating aspects of the system), a wheel-type selection feature (e.g., as shown in FIG. 4 demonstrating aspects of the system), a tick box, a manual entry field, etc. In some implementations, the options displayed in the selection feature may be automatically populated based on the curriculum data, thereby reducing and/or eliminating the need to subsequently match a data record generated based on the new entry with the various goals and/or sub-goals of a curriculum. Moreover, the immediate linking of the new entry with the goal and/or sub-goal of the curriculum data may provide subsequent documentary proof of compliance with a mandatory curriculum, such as Common Core State Standards, the Head Start Child Development, Early Learning Framework, state-specific curriculums, etc.

The process 200 further includes selecting one or more students or children to be associated with the new entry (block 206). The selection of one or more students or children to be associated with the new entry may be done through a selection feature of the user interface, such as a drop-down menu, a wheel-type selection feature, a tick box, a manual entry field, etc. In some implementations, the options displayed in the selection feature may be automatically populated based on data from the back-end server 110, such as a database containing a class or group listing, etc. The selection of one or more students for the new entry may be based on a linking of identifiers associated with the one or more students to the new entry.

The process 200 includes selecting additional information or data to be associated with the new entry (block 208). The additional information or data may include a date, an activity, a mood, a picture, a video, a drawing, a document, a status update, a description, a category, a time, a location, etc. In some implementations, the user interface may include a camera selection feature such that a teacher device having a camera, such as a tablet and/or mobile device, may access a camera application to capture and include data for the picture and/or video taken by the camera. In some implementations, one or more tags can be selected for a picture or image of the new entry. The selection of one or more tags to be associated with the new entry may be done through a selection feature of the user interface, such as a drop-down menu, a wheel-type selection feature, a tick box, a manual entry field, etc. In some implementations, the options displayed in the selection feature may be automatically populated based on data from the back-end server 110, such as a set of educational goals or educational development categories, etc.

The process 200 also includes the generation of a new entry based on the aforementioned selections (block 210). For instance, the new entry may be generated in response to a selection of a draft saving selection feature, such as those shown in FIGS. 3 and 5. Identifiers for the selected goal and/or sub-goal, identifiers for the selected one or more students or children, and the selected and/or entered additional information or data may then be added as data entries to the new entry data file and stored in a data store, e.g., memory, of the teacher device 140. In some implementations, the draft new entry may be transmitted to the back-end server 110 as a draft new entry to be subsequently access and/or modified at a later time (e.g., by the teacher via the same or another teacher device 140).

In other instances, the new entry may be generated in response to a selection of a post, done, or send selection feature, such as those shown in FIGS. 3-5. The identifiers for the selected goal and/or sub-goal, identifiers for the selected one or more students or children, and the selected and/or entered additional information or data may then be added as data entries to the new entry data file and the teacher device transmits the new entry data file to the back-end server 110.

FIGS. 3-5 demonstrate aspects of the system displayable on a teacher device 140 for generating the new entries to be transmitted and stored in a record database 112 of the back-end server 110. FIG. 3 depicts an example of a web-based interface 300 for generating a new entry data file, including a selection of one or more identifiers or tags for the selected goal and/or sub-goal for the new entry. In some implementations, the one or more identifiers or tags for the selected goal and/or sub-goal may be selected for a picture or image of the new data entry. FIG. 4 depicts an example of a mobile interface 400 for generating a new entry data file, including a selection of one or more identifiers or tags for the selected goal and/or sub-goal for the new entry. In some implementations, the one or more identifiers or tags for the selected goal and/or sub-goal may be selected for a picture or image of the new data entry. FIG. 5 depicts another example interface 500 for generating a new entry data file, including a selection of one or more identifiers or tags for the selected goal and/or sub-goal for the new entry. In some implementations, the one or more identifiers or tags for the selected goal and/or sub-goal may be selected for a picture or image of the new data entry.

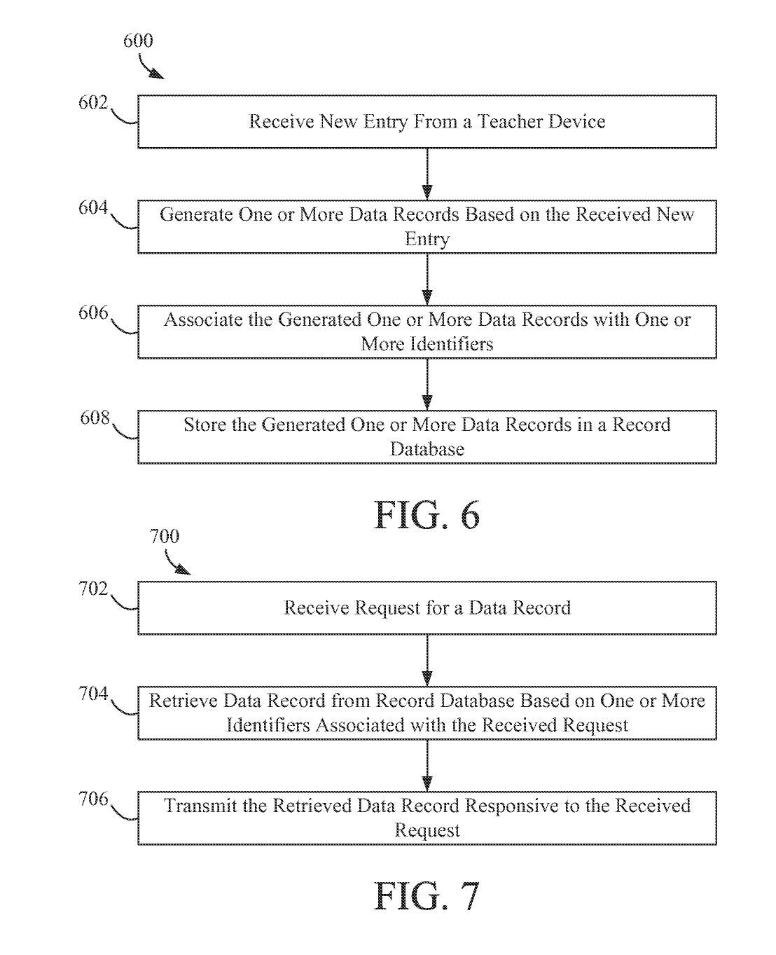

FIG. 6 depicts a process 600 for the back-end server 110 that receives a new entry data file from a teacher device 140 and generates one or more data records from the new entry. The process 600 may execute on the back-end server 110 to perform the operations described by the process 600. The process 600 includes receiving a new entry from a teacher device (block 602). The new entry may be received via a network 160, such as that depicted in FIG. 1. The process 600 also includes generating one or more data records based on the received new entry (block 604). The generation of the one or more data records may be based on the identifiers for the selected goal and/or sub-goal, identifiers for the selected one or more students or children, one or more associated tags, and/or the selected and/or entered additional information or data. For instance, the back-end server 110 may generate several different data records for each student or child identified in the new entry to maintain separate data records. In other implementations, the back-end server 110 may generate a single data record and limit accessibility to the data record based on the identifiers for the selected one or more students or children.

The process 600 also includes associating the generated one or more data records with one or more identifiers (block 606). In some implementations, the back-end server 110 may generate metadata for the one or more data records based on the identifiers for the selected goal and/or sub-goal, identifiers for the selected one or more students or children, one or more associated tags, and/or the selected and/or entered additional information or data to permit indexing, searching, and/or filtering of the data records stored in the record database. The process 600 further includes storing the generated one or more data records in a record database (block 608).

FIG. 7 depicts a process 700 for the back-end server 110 to receive a request from a parent device 130 for a data record and to retrieve and transmit the data record responsive to the request. The process 700 includes receiving a request for a data record (block 702). The request may be received from a parent device 130, an administrator device 120, and/or a teacher device 140. In some implementations, the request may include an identifier associated with the particular data record, an identifier associated with a particular student or child for the data record, an identifier associated with a particular goal or sub-goal, an identifier associated with a tag and/or plurality of tags, etc. The process 700 includes the back-end server 110 retrieving the data record from the record database based on the one or more identifiers included or associated with the received request (block 704). The process 700 further includes the back-end server 110 transmitting the retrieved data record responsive to the received request (block 706). In some implementations, the back-end server 110 may transmit a set of one or more identifiers of data records to a device prior to receiving a request for a particular data record.

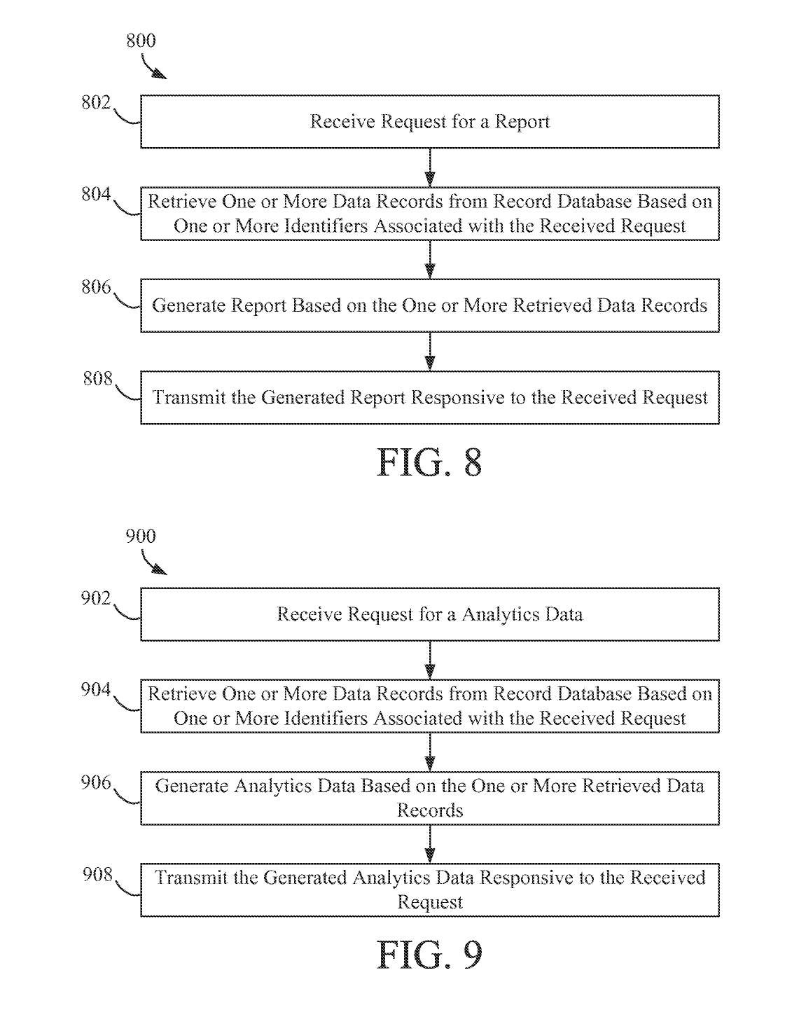

FIG. 8 depicts a process 800 for the back-end server 110 to receive a request for a report, generate the report using a report generation system, and transmit the report responsive to the request. The process 800 includes receiving a request for a report (block 802). The request may be received from a parent device 130, an administrator device 120, and/or a teacher device 140. In some implementations, the request may include an identifier associated with a particular student or child for the data record, an identifier associated with a particular goal or sub-goal, an identifier for one or more tags, an identifier associated with a particular day, an identifier associated with a particular class or group, an identifier associated with a particular teacher, etc. The process 800 includes a report generation system 114 of the back-end server 110 retrieving one or more data records from the record database 112 based on the one or more identifiers included or associated with the received request (block 804). The process 800 further includes the report generation system 114 of the back-end server 110 generating a report based on the one or more retrieved data records (block 806). The process 800 further includes the report generation system 114 of the back-end server 110 transmitting the generated report responsive to the received request (block 808).

FIG. 9 depicts a process 900 for the back-end server 110 to receive a request for analytics data, generate the analytics data using a data analytics system 116, and transmit the generated analytics data responsive to the request. The process 900 includes receiving a request for a analytics data (block 902). The request may be received from a parent device 130, an administrator device 120, and/or a teacher device 140. In some implementations, the request may include an identifier associated with a particular student or a for the data record, an identifier associated with a particular goal or sub-goal, an identifier associated with one or more tags, an identifier associated with a particular class or group, an identifier associated with a particular teacher, etc. The process 900 includes a data analytics system 116 of the back-end server 110 retrieving one or more data records from the record database 112 based on the one or more identifiers included or associated with the received request (block 904). The process 900 further includes the data analytics system 116 of the back-end server 110 generating analytics data based on the one or more retrieved data records (block 906). In some implementations, the analytics data may be a completion percentage, such as a number of goals and/or sub-goals completed and/or above a predetermined level (e.g., satisfactory and above) compared to the total number of goals and/or sub-goals. In some implementations, the analytics data may also include a number of data records per goal and/or sub-goal (e.g., the number of activities performed per goal and/or sub-goal). In some implementations, the data analytics system 116 can generate the analytics data based one aggregating one or more tags into a number of tags. The one or more tags may be retrieved from data associated with one or more images or pictures. For instance, if ten images are tagged with the educational development category tag of “science,” then the aggregated number for the “science” tag is ten. Based on the aggregated number of tags, the data analytics system 116 can generate a development score using a predetermined threshold. For instance, if the predetermined threshold is twenty (i.e., corresponding to having an educational goal of twenty science events and/or experiences), then the development score can be calculated as 50% based on the ten aggregated tags and the predetermined threshold of twenty using a linear algorithm. In some implementations, the predetermined threshold may be based on a curriculum for the student, class, school, etc. In other implementations, more complex algorithms for the development score may be implemented (e.g., having the development score be based on a weighted value for the aggregated tags, having the development score be based on a multi-variable weighted function of several aggregated tags, etc.). As will be discussed in greater detail herein, the development score may be used for generating progress reports and/or for recommending one or more applications. In some implementations, an aggregate development score may be calculated from one or more development scores and/or directly from aggregated numbers of tags and the predetermined threshold values. In some implementations, the data analytics system 116 can directly access the plurality of tags without accessing the images.

In some further implementations, the data analytics system 116 may generate display data for a visualization of the analytics data. The display data can include a graphical chart generated based on the analytics data. The process 900 also includes the data analytics system 116 of the back-end server 110 transmitting the generated analytics data responsive to the received request (block 908).

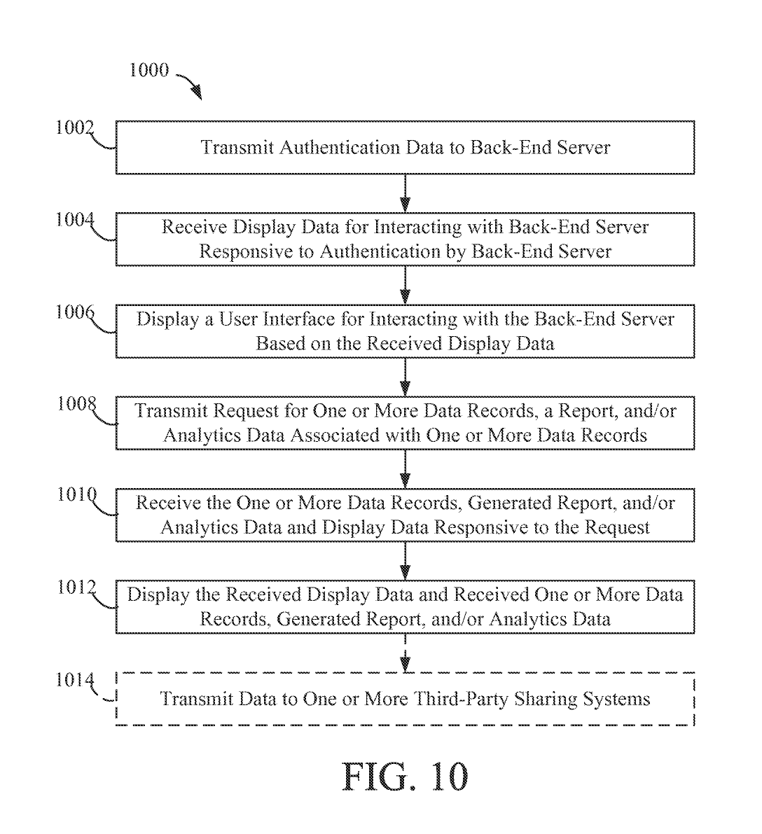

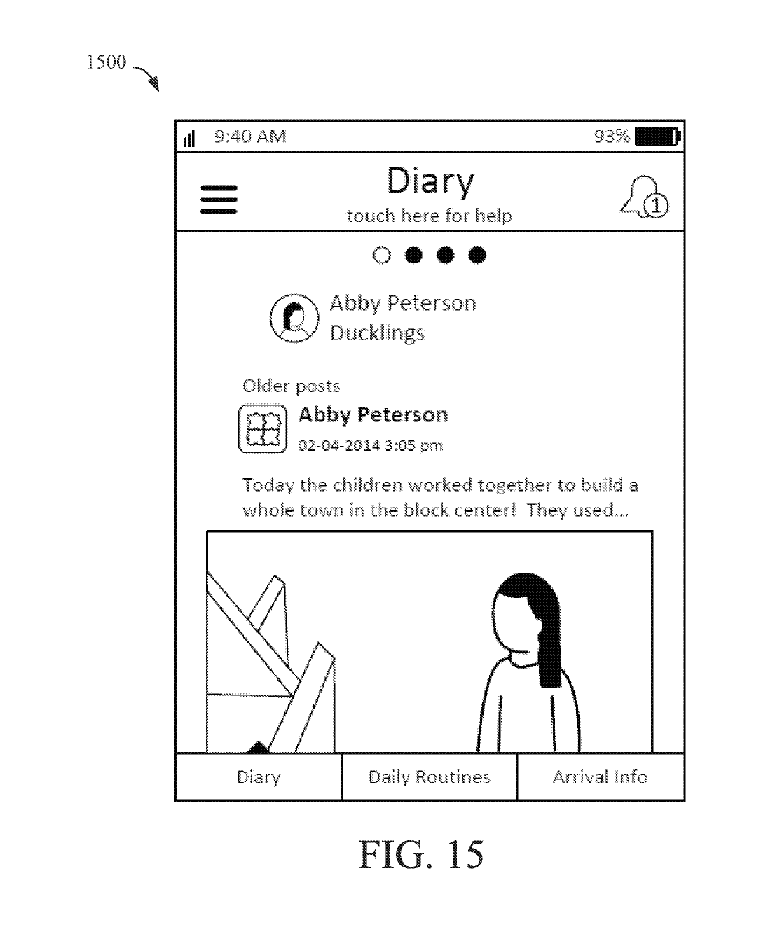

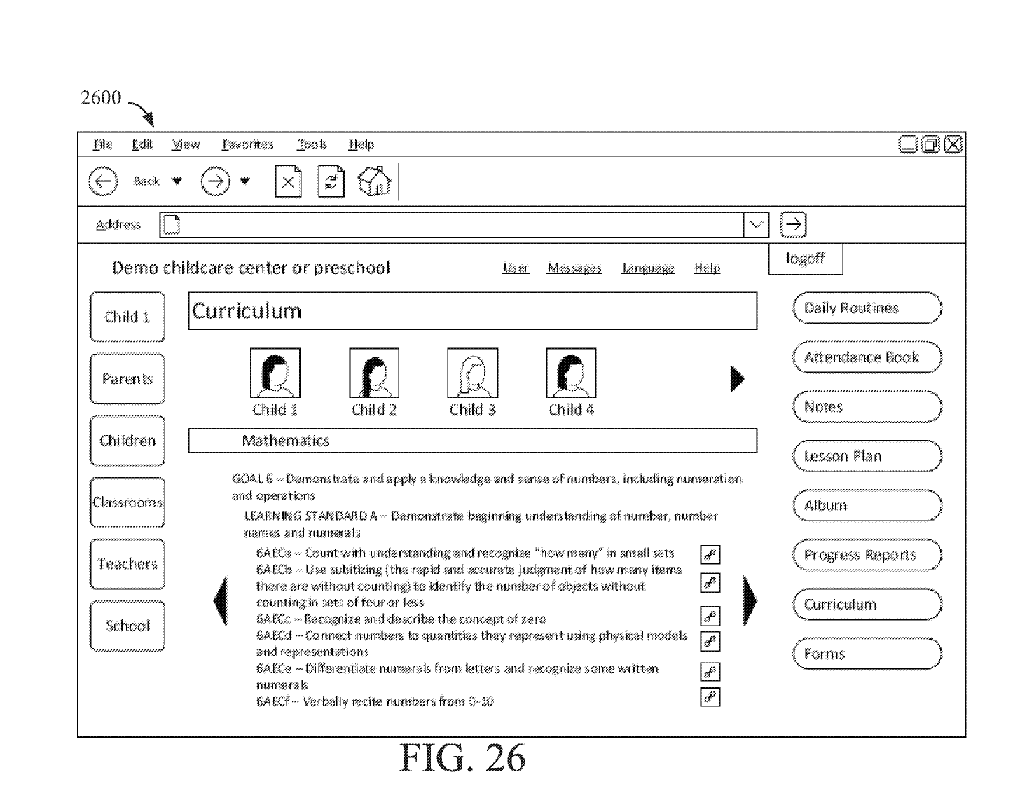

FIG. 10 depicts a process 1000 for a parent device 130 to log into a service to access and/or interact with the back-end server 110, transmit a request for one or more data records, a report, and/or analytics data, and display the one or more data records, report, and/or analytics data. The process 1000 includes transmitting authentication data to the back-end server (block 1002). In some implementations, the parent device 130 may execute an application and/or access a web interface via a browser to connect to the back-end server 110. An interface of the application and/or web interface may include a login page for the user of the parent device 130 to enter authentication credentials (e.g., username and password and/or other authentication credentials). The process 1000 may include the parent device 130 receiving display data for an interface for interacting with the back-end server 110 responsive to the back-end server 110 authenticating the transmitted authentication data (block 1004). For instance, the display data may include display data for the interface 1500, 2600 depicted in FIG. 15 or FIG. 26 demonstrating aspects of the system. The process 100 may include the parent device 130 generating and/or displaying, on a display device of the parent device 130, the user interface for interacting with the back-end server 110 based on the received display data (block 1006).

A user of the parent device 130 may then interact with the user interface to access and/or otherwise interact with the back-end server 110. For instance, the process 1000 may include transmitting a request for one or more data records, a report, and/or analytics data associated with one or more data records (block 1008). In some implementations, and application and/or web interface displayed on a display of the parent device 130 may include a feed of activity, such as a feed shown in the user interface 1500 of FIG. 15 demonstrating aspects of the system, associated with a student or child of the user of the parent device 130. Such a feed of activity may be populated by transmitting a request to the back-end server 110 for one or more data records associated with an identifier for the particular student or child.

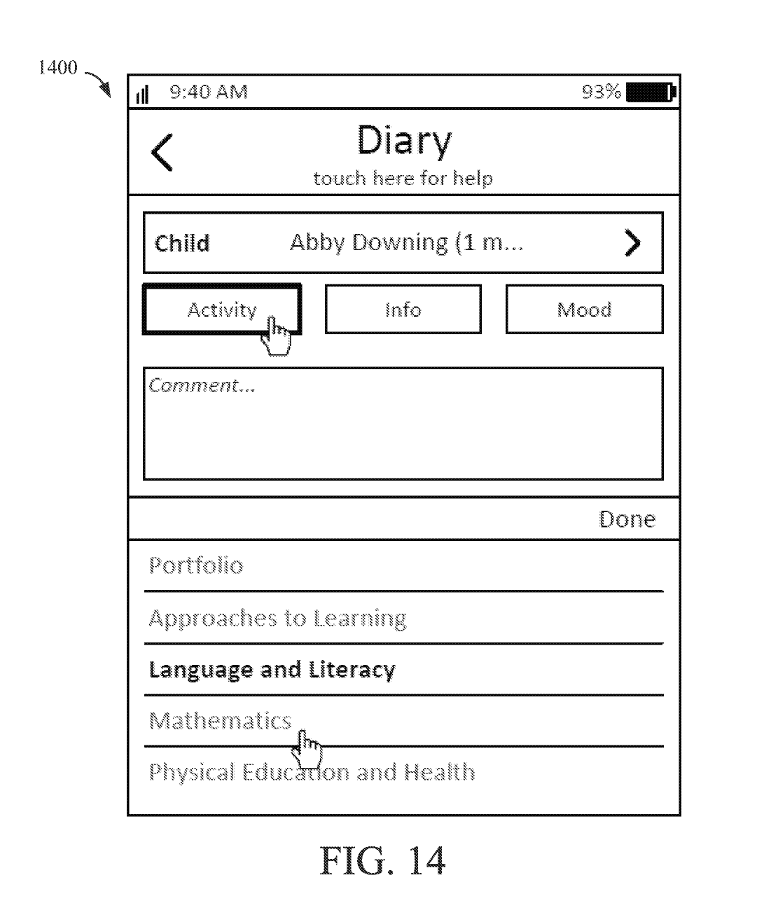

In some instances, the request for one or more data records may be performed in response to a selection of a selection feature of a user interface displayed on a display of the parent device 130. For instance, the selection feature may be a button for one or more data records associated with a particular data record, a particular goal or sub-goal, a particular tag, a particular day, a particular class or group, a particular teacher, a particular subject, etc. For instance, a user interface 140 such as that shown in FIG. 14 demonstrating aspects of the system may include a wheel selection feature to select a particular subject (or a particular data record, a particular goal or sub-goal, a particular day, a particular class or group, a particular teacher, etc.) for a student or child associated with the user of the parent device 130. Responsive to the selection, a request for data records associated with an identifier for the subject and for the student or child may be transmitted to the back-end server 110.

In some implementations, a request for a report may be performed in response to a selection of a selection feature of a user interface displayed on a display of the parent device 130. For instance, the selection feature may be a button for a report associated with a particular goal or sub-goal, a particular tag, a particular day, a particular class or group, a particular teacher, a particular subject, etc. For instance, the user interface 1400 shown in FIG. 14 demonstrating aspects of the system may be used to select a particular subject (or a particular data record, a particular goal or sub-goal, a particular tag, a particular day, a particular class or group, a particular teacher, etc.) for the report for a student or child associated with the user of the parent device 130. Responsive to the selection, a request for a report based on the data records associated with an identifier for the subject and for the student or child may be transmitted to the back-end server 110.

In some implementations, a request for analytics data may be performed in response to a selection of a selection feature of a user interface displayed on a display of the parent device 130. For instance, the selection feature may be a button for requesting analytics data associated with a particular goal or sub-goal, a particular tag, a particular day, a particular class or group, a particular teacher, a particular subject, etc. For instance, the user interface 1400 shown in FIG. 14 demonstrating aspects of the system may be used to select a particular subject (or a particular data record, a particular goal or sub-goal, a particular tag, a particular day, a particular class or group, a particular teacher, etc.) for the analytics data for a student or child associated with the user of the parent device 130. Responsive to the selection, a request for analytics data based on the data records associated with an identifier for the subject and for the student or child may be transmitted to the back-end server 110.

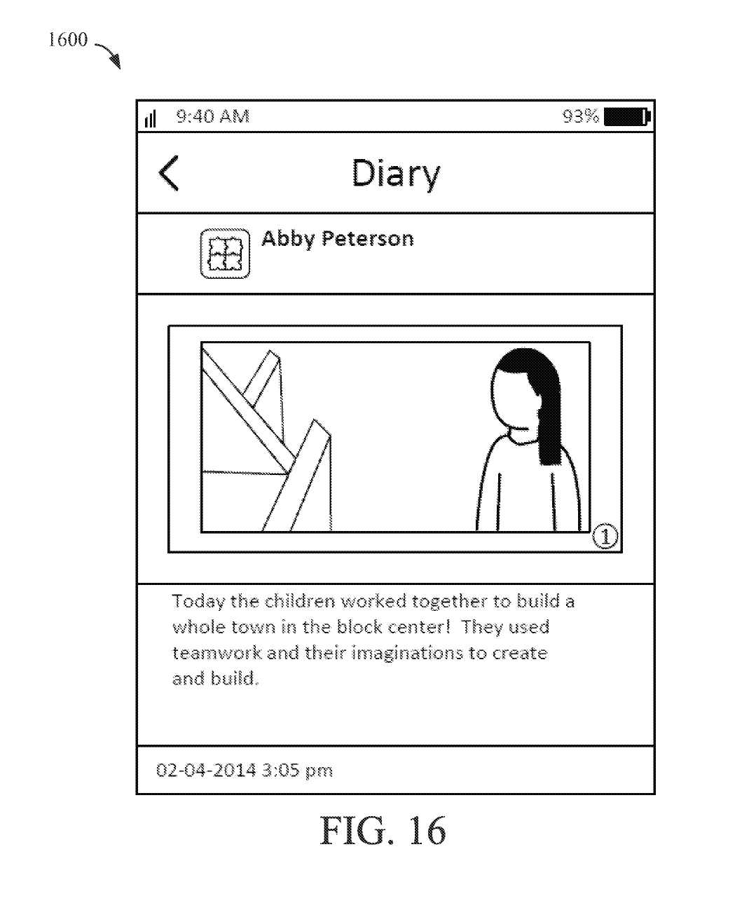

Still referring to FIG. 10, the process 1000 may further include receiving the requested one or more data records, report, and/or analytics data and display data responsive to the request (block 1010) and displaying the received display data and the received one or more data records, report, and/or analytics data (block 1012). For instance, the back-end server 110 may receive the request for a particular data record. The back-end server 110 may then retrieve the data record and transmit the data record to the parent device 130. In some implementations, the back-end server 110 may also include display data for displaying the data record on a display of the parent device 130. For instance, the particular data record may be displayed via a user interface such as the data record shown in the user interface 1600 of FIG. 16 demonstrating aspects of the system.

In other instances, the back-end server 110 may receive the request for a report. A report generation system 114 of the back-end server 110 retrieves one or more data records from the record database 112 to generate the report of the request and generates the report based on the one or more retrieved data records. The generated report is transmitted to the parent device 130 from the report generation system 114 of the back-end server 110. In some implementations, the report generation system 114 and/or back-end server 110 may also include display data for displaying the report on a display of the parent device 130. For instance, the report may be displayed via a user interface such as the reports shown in the user interfaces 1100, 1200, 1300 of FIGS. 11-13 demonstrating aspects of the system that depict reports for a particular activity of a student or child and/or a report on an activity of a class, group, etc.

In still further instances, the back-end server may 110 receive the request for analytics data. A data analytics system 116 of the back-end server 110 retrieves one or more data records from the record database 112 to generate the analytics data of the request and generates the analytics data based on the one or more retrieved data records. The generated analytics data is transmitted to the parent device 130 from the data analytics system 116 of the back-end server 110. In some implementations, the data analytics system 116 and/or back-end server 110 may also generate and/or include display data for displaying the analytics data on a display of the parent device 130. For instance, the analytics data may be displayed via a user interface such as the user interfaces 1900, 2000, 2100, 2200 incorporating the analytics data and display data for visual/graphical representations of the analytics data of FIGS. 19-22 demonstrating aspects of the system that depict reports for a particular activity of a student or child and/or a report on an activity of a class, group, etc. The analytics data may be generated in accordance with the process 900 of FIG. 9.

In some implementations, the data records, report, and/or analytics data may be filtered, such as by the developmental goals and/or sub-goals of a curriculum (e.g., Common Core State Standards, the Head Start Child Development, Early Learning Framework, state-specific curriculum, and/or any other curriculum) and/or based on one or more tags.

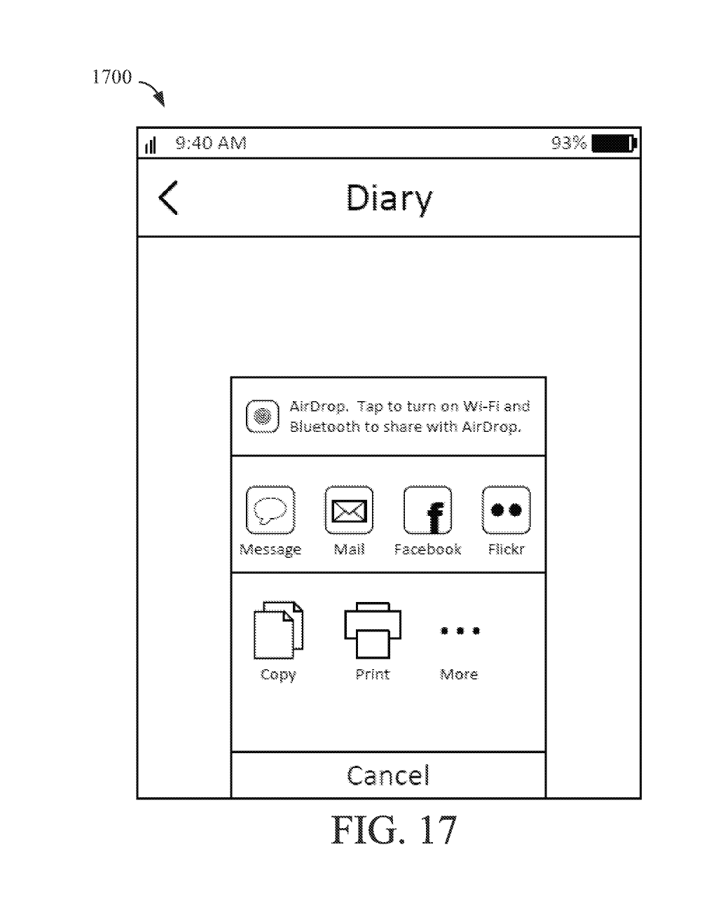

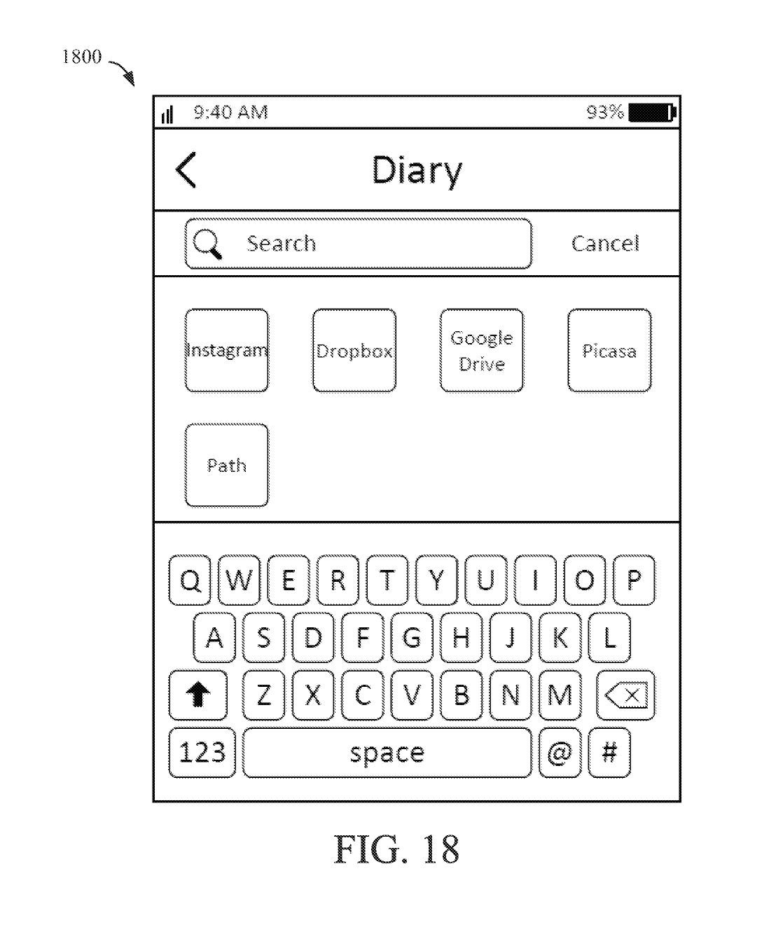

In some implementations, the process 1000 may also include transmitting data to one or more third-party sharing systems (block 1014), such as data for one or more data records, reports, analytics data, and/or portions thereof (e.g., photos, videos, etc.) received from the back-end server 110. For instance, one or more selection features (e.g., icons) displayed with the one or more data records, reports, analytics data, and/or portions thereof may, when selected, request the user of the parent device 130 to specify a third-party sharing system to which the one or more data records, reports, analytics data, and/or portions thereof is to be transmitted, such as shown in interfaces 1700, 1800 of FIGS. 17-18 that demonstrate aspects of the system. Responsive to a selection of a selection feature, data for one or more data records, reports, analytics data, and/or portions thereof (e.g., photos, videos, etc.) may be transmitted to the third-party sharing system (e.g., Picassa, Instagram, Facebook, Dropbox, Google Drive®, Pintrest, etc.). In other instances, the process 1000 may also include transmitting data via a message (e.g., SMS message) and/or as an attachment to an e-mail. In still further implementations, the data may be copied to a clipboard of the parent device 130 and/or sent to an external device (e.g., a printer).

In some implementations, a calendar integration feature may be provided as part of the system described herein. In some implementations, when the parent device 130 executes the application and/or accesses the web interface to access the back-end server 110, the back-end server 110 may provide data to sync a calendar of the back-end server associated with an identifier for the student or child of the user of the parent device 130 with a calendar of the parent device 130. In some implementations the calendar data sync may be responsive to a selection of sync selection feature of an interface and/or the calendar sync may be automatic (e.g., pushing the calendar data upon being added to the calendar of the back-end server 110, at predetermined intervals, and/or upon executing the application and/or accessing the web interface). Thus, teachers and/or administrators may schedule conferences or events for the student or child, and users of the parent device 130 can automatically have such conferences or events integrated with a calendar of the parent device 130.

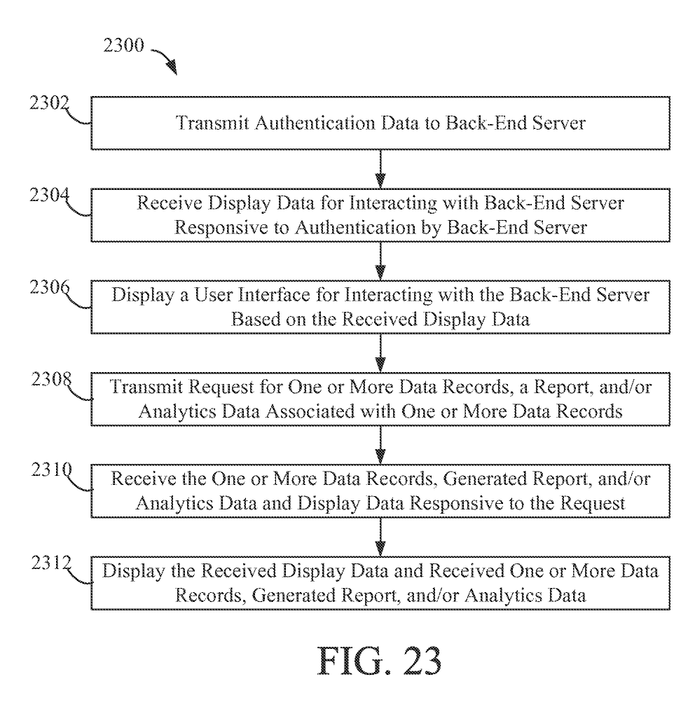

FIG. 23 depicts a process 2300 for an administrator device 120 and/or teacher device 140 to log into a service to access and/or interact with the back-end server 110, transmit a request for one or more data records, a report, and/or analytics data, and display the one or more data records, report, and/or analytics data. The process 2300 includes transmitting authentication data to the back-end server (block 2302). In some implementations, the administrator device 120 and/or teacher device 140 may execute an application and/or access a web interface via a browser to connect to the back-end server 110. An interface of the application and/or web interface may include a login page for the user of the administrator device 120 or teacher device 140 to enter authentication credentials (e.g., username and password and/or other authentication credentials). The process 2300 may include the administrator device 120 and/or teacher device 140 receiving display data for an interface for interacting with the back-end server 110 responsive to the back-end server 110 authenticating the transmitted authentication data (block 2304). For instance, the display data may include display data for the interface 1500, 2600 depicted in FIG. 15 or FIG. 26 demonstrating aspects of the system. The process 2300 may include the administrator device 120 and/or teacher device 140 generating and/or displaying, on a display device of the administrator device 120 and/or teacher device 140, the user interface for interacting with the back-end server 110 based on the received display data (block 2306).

A user of the administrator device 120 and/or teacher device 140 may then interact with the user interface to access, modify, and/or otherwise interact with the back-end server 110. For instance, the process 2300 may include transmitting a request for one or more data records, a report, and/or analytics data associated with one or more data records (block 2308). In some instances, the request for one or more data records may be performed in response to a selection of a selection feature of a user interface displayed on a display of the administrator device 120 and/or teacher device 140. For instance, the selection feature may be a button for one or more data records associated with a particular data record, a particular goal or sub-goal, a particular tag, a particular day, a particular class or group, a particular teacher, a particular subject, aggregated goals or sub-goals, aggregated tags, a particular student or child, aggregated classes or groups, the entirety of a school or other educational facility, etc. For instance, a user interface 1400 such as that shown in FIG. 14 demonstrating aspects of the system may include a wheel selection feature to select a particular subject (or a particular data record, a particular goal or sub-goal, a particular tag, a particular day, a particular class or group, a particular teacher, a particular student or child, aggregated goals or sub-goals, aggregated classes or groups, the entirety of a school or other educational facility, etc.). Responsive to the selection, a request for data records associated with an identifier for the particular data record, particular goal or sub-goal, particular tag, particular day, particular class or group, particular teacher, particular student or child, aggregated goals or sub-goals, aggregated tags, aggregated classes or groups, the entirety of a school or other educational facility, etc. may be transmitted to the back-end server 110.

In some implementations, a request for a report may be performed in response to a selection of a selection feature of a user interface displayed on a display of the administrator device 120 or teacher device 140. For instance, the selection feature may be a button for a report associated with a particular goal or sub-goal, a particular tag, a particular day, a particular class or group, a particular teacher, a particular subject, a particular student or child, aggregated goals or sub-goals, aggregated tags, aggregated classes or groups, the entirety of a school or other educational facility, etc. For instance, the user interface 1400 shown in FIG. 14 demonstrating aspects of the system may be used to select a particular subject (or a particular data record, a particular goal or sub-goal, a particular tag, a particular day, a particular class or group, a particular teacher, a particular student or child, aggregated goals or sub-goals, aggregated tags, aggregated classes or groups, the entirety of a school or other educational facility, etc.) for the report. Responsive to the selection, a request for a report based on the data records associated with an identifier for the particular data record, particular goal or sub-goal, particular tag, particular day, particular class or group, particular teacher, particular student or child, aggregated goals or sub-goals, aggregated tags, aggregated classes or groups, the entirety of a school or other educational facility, etc. may be transmitted to the back-end server 110.

In some implementations, a request for analytics data may be performed in response to a selection of a selection feature of a user interface displayed on a display of the administrator device 120 and/or teacher device 140. For instance, the selection feature may be a button for requesting analytics data associated with a particular goal or sub-goal, a particular tag, a particular day, a particular class or group, a particular teacher, a particular subject, a particular student or child, aggregated classes or groups, the entirety of a school or other educational facility, etc. For instance, the user interface 1400 shown in FIG. 14 demonstrating aspects of the system may be used to select a particular subject (or a particular data record, a particular goal or sub-goal, a particular tag, a particular day, a particular class or group, a particular teacher, a particular student or child, aggregated classes or groups, the entirety of a school or other educational facility, etc.) for the analytics data. Responsive to the selection, a request for analytics data based on the data records associated with the particular data record, particular goal or sub-goal, particular tag, particular day, particular class or group, particular teacher, particular student or child, aggregated goals or sub-goals, aggregated tags, aggregated classes or groups, the entirety of a school or other educational facility, etc. may be transmitted to the back-end server 110.

Still referring to FIG. 23, the process 2300 may further include receiving the requested one or more data records, report, and/or analytics data and display data responsive to the request (block 2310) and displaying the received display data and the received one or more data records, report, and/or analytics data (block 2312). For instance, the back-end server 110 may receive the request for a particular data record. The back-end server 110 may then retrieve the data record and transmit the data record to the administrator device 120 and/or teacher device 140. In some implementations, the back-end server 110 may also include display data for displaying the data record on a display of the administrator device 120 and/or teacher device 140. For instance, the particular data record may be displayed via a user interface such as the data record shown in the user interface 1600 of FIG. 16 demonstrating aspects of the system.

In other instances, the back-end server 110 may receive the request for a report. A report generation system 114 of the back-end server 110 retrieves one or more data records from the record database 112 to generate the report of the request and generates the report based on the one or more retrieved data records. The generated report is transmitted to the administrator device 120 and/or teacher device 140 from the report generation system 114 of the back-end server 110. In some implementations, the report generation system 114 and/or back-end server 110 may also include display data for displaying the report on a display of the administrator device 120 and/or teacher device 140. For instance, the report may be displayed via a user interface such as the reports shown in the user interfaces 1100, 1200, 1300 of FIGS. 11-13 demonstrating aspects of the system that depict reports for a particular activity of a student or child and/or a report on an activity of a class, group, etc.

In still further instances, the back-end server 110 may receive the request for analytics data. A data analytics system 116 of the back-end server 110 retrieves one or more data records from the record database 112 to generate the analytics data of the request and generates the analytics data based on the one or more retrieved data records. The generated analytics data is transmitted to the administrator device 120 and/or teacher device 130 from the data analytics system 116 of the back-end server 110. In some implementations, the data analytics system 116 and/or back-end server 110 may also generate and/or include display data for displaying the analytics data on a display of the administrator device 120 and/or teacher device 140. For instance, the analytics data may be displayed via a user interface such as the user interfaces 1900, 2000, 2100, 2200 incorporating the analytics data and display data for visual/graphical representations of the analytics data of FIGS. 19-22 demonstrating aspects of the system that depict reports for a particular activity of a student or child and/or a report on an activity of a class, group, etc.

In some implementations, the data records, report, and/or analytics data may be filtered, such as by the developmental goals and/or sub-goals of a curriculum (e.g., Common Core State Standards, the Head Start Child Development, Early Learning Framework, state-specific curriculum, and/or any other curriculum) and/or one or more tags.

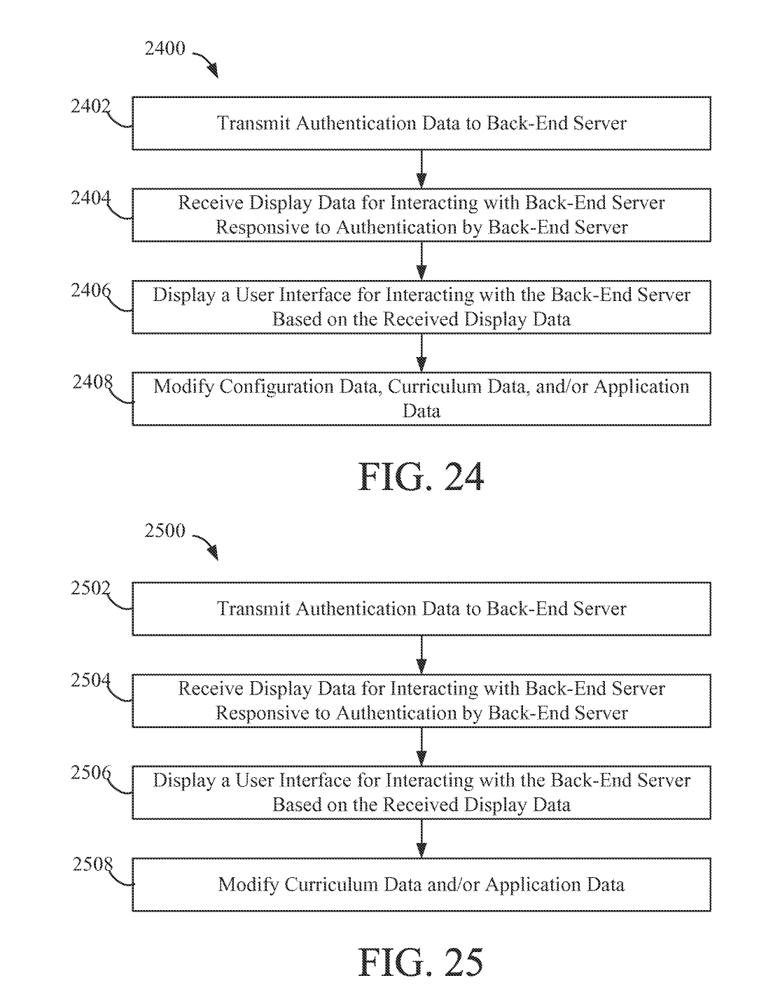

FIG. 24 depicts a process 2400 for an administrator device 120 to log into a service to access and/or interact with the back-end server 110 and to modify configuration data, curriculum data, and/or application data. The process 2400 includes transmitting authentication data to the back-end server (block 2402). In some implementations, the administrator device 120 may execute an application and/or access a web interface via a browser to connect to the back-end server 110. An interface of the application and/or web interface may include a login page for the user of the administrator device 120 to enter authentication credentials (e.g., username and password and/or other authentication credentials). The administrator device 120 may receive display data for an interface for interacting with the back-end server 110 responsive to the back-end server 110 authenticating the transmitted authentication data (block 2404). For instance, the display data may include display data for the interface 2600 depicted in FIG. 26 demonstrating aspects of the system. The administrator device 120 generates and displays, on a display device of the administrator device 120, the user interface for interacting with the back-end server 110 based on the received display data (block 2406). A user of the administrator device 120 may then interact with the user interface to access, modify, and/or otherwise interact with the back-end server 110. For instance, a user of the administrator device 120 may modify configuration data for the back-end server 110, modify curriculum data (e.g., adding, changing, and/or deleting goals and/or sub-goals), and/or modify application data (block 2408).

FIG. 25 depicts a process 2500 for a teacher device 140 to log into a service to access and/or interact with the back-end server 110 and to modify curriculum data and/or application data. The process 2500 includes transmitting authentication data to the back-end server (block 2502). In some implementations, the teacher device 140 may execute an application and/or access a web interface via a browser to connect to the back-end server 110. An interface of the application and/or web interface may include a login page for the user of the teacher device 140 to enter authentication credentials (e.g., username and password and/or other authentication credentials). The teacher device 140 may receive display data for an interface for interacting with the back-end server 110 responsive to the back-end server 110 authenticating the transmitted authentication data (block 2504). For instance, the display data may include display data for the interface 2600 depicted in FIG. 26 demonstrating aspects of the system. The teacher device 140 generates and displays, on a display device of the teacher device 140, the user interface for interacting with the back-end server 110 based on the received display data (block 2506). A user of the teacher device 140 may then interact with the user interface to access, modify, and/or otherwise interact with the back-end server 110. For instance, a user of the teacher device 110 may modify curriculum data (e.g., adding, changing, and/or deleting goals and/or sub-goals) and/or modify application data (block 2508).

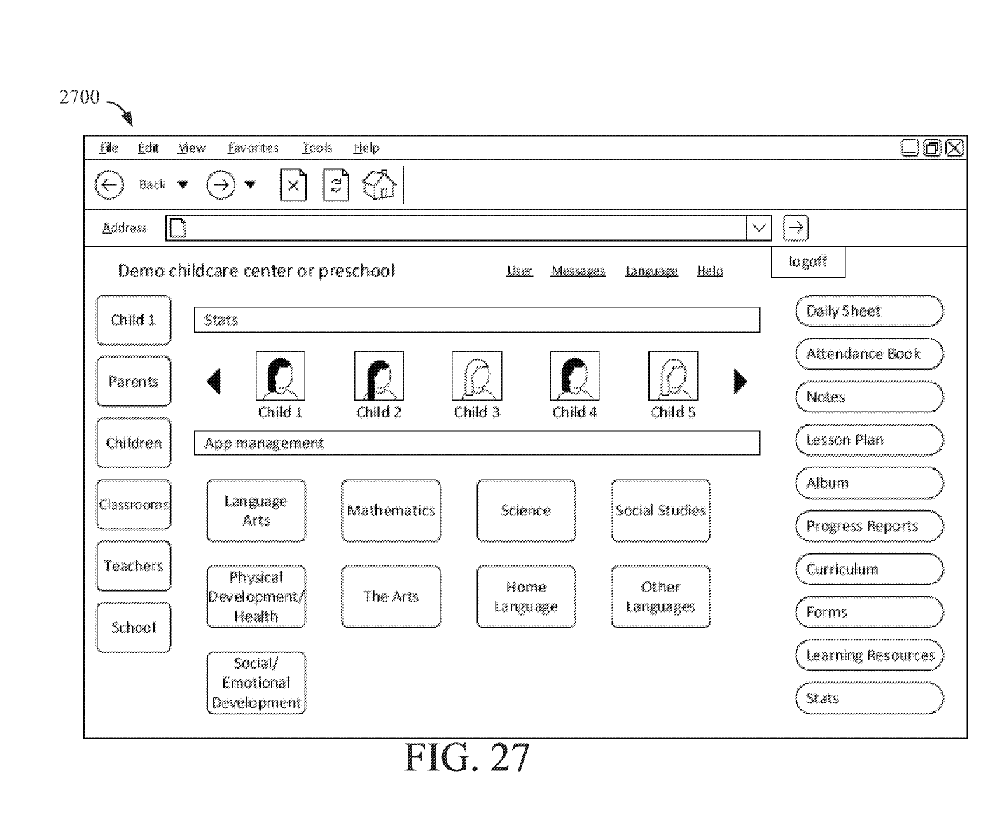

In some implementations, the modification of the application data may include adding, changing, and/or removing applications or application links from the application database 118. For instance, a user of the administrator device 120 or teacher device 140 may access a sub-user interface, such as the interface 2700 shown in FIG. 27 demonstrating aspects of the system, for application management. In some instances, the application management sub-user interface 2700 may include one or more selection icons or other selection features corresponding to one or more subjects of a curriculum defined in the curriculum data, such as subjects corresponding to Common Core State Standards, the Head Start Child Development, Early Learning Framework, state-specific curriculum subjects, and/or any other curriculum subjects.

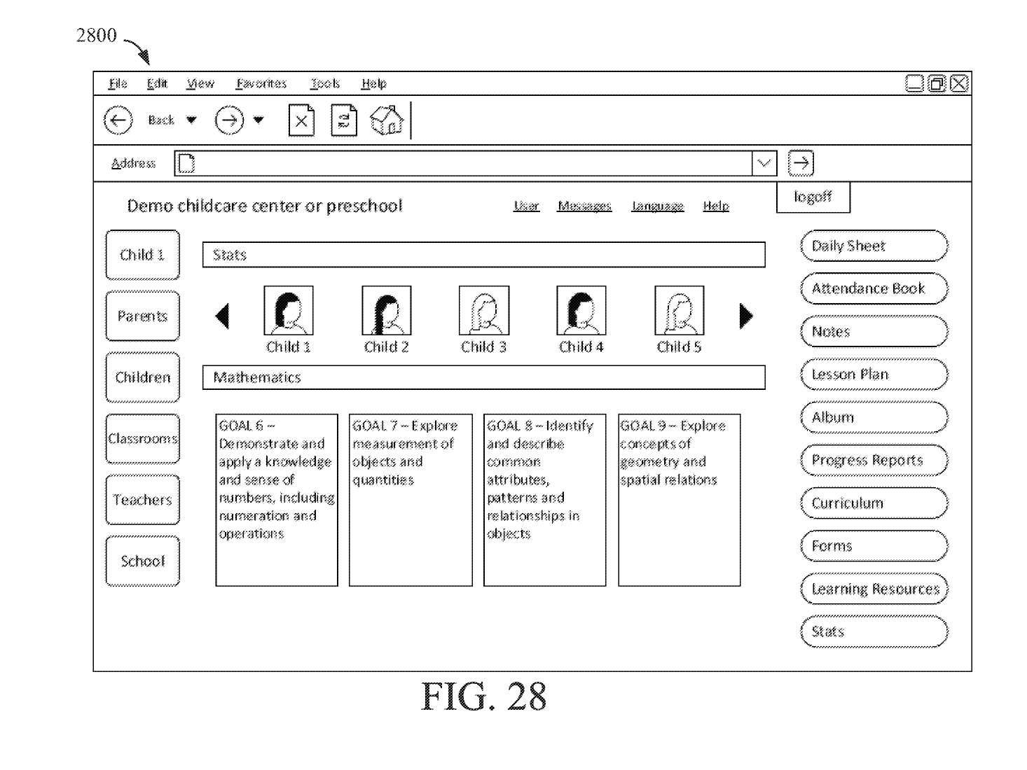

Responsive to a selection of an icon corresponding to a subject of the curriculum, a user of the administrator device 120 or teacher device 140 may be presented with another sub-user interface, such as the interface 2800 shown in FIG. 28 demonstrating aspects of the system, having icons or other selection features for selecting a goal and/or sub-goal for the selected subject, such as goals and/or sub-goals corresponding to Common Core State Standards, the Head Start Child Development, Early Learning Framework, state-specific curriculum goals and/or sub-goals, and/or any other curriculum goals and/or sub-goals, and/or one or more tags.

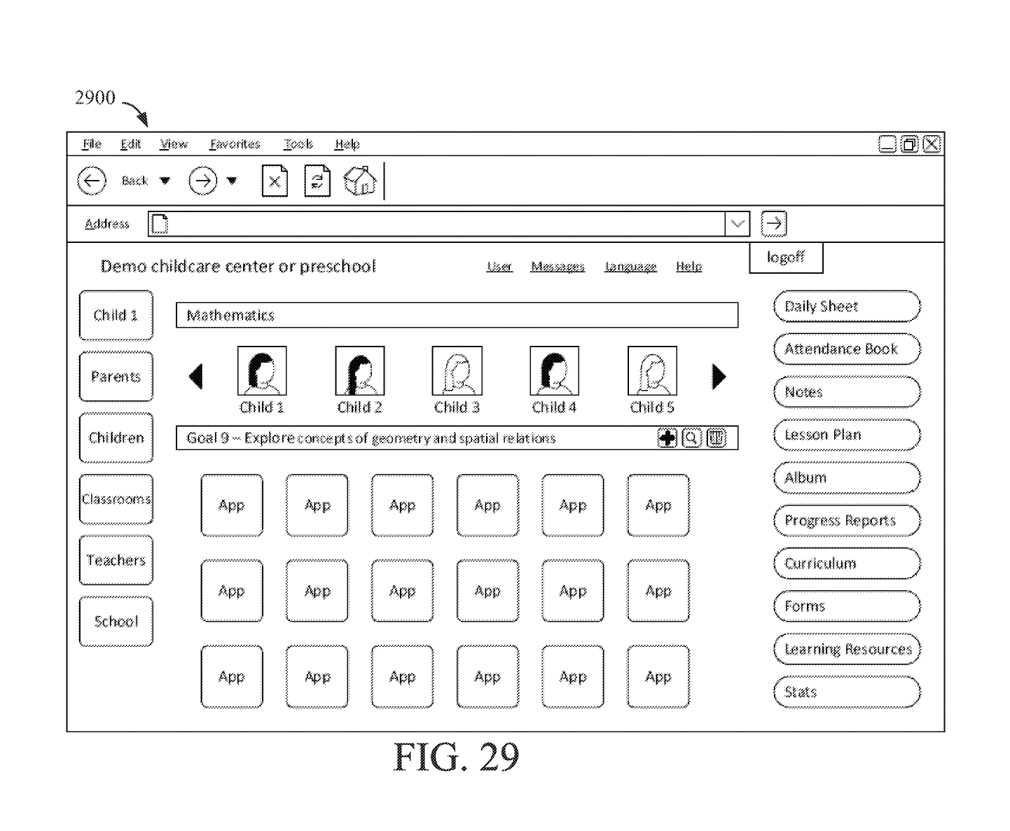

Responsive to a selection of an icon corresponding to a selected goal and/or sub-goal for the selected subject and/or a tag, a user of the administrator device 120 or teacher device 140 may be presented with yet another sub-user interface, such as the interface 2900 shown in FIG. 29 demonstrating aspects of the system, for selecting one or more applications associated with the goal and/or sub-goal for the selected subject. A user of the administrator device 120 or teacher device 140 may add, modify, and/or remove the one or more applications (e.g., Ready Rosie, Mrs. Judd's Crabby Writer, Kindermusik Radio App, etc.) via the sub-user interface. For instance, the user of the administrator device 120 or teacher device 140 may select an add selection feature to add an application to the sub-user interface 2900. In some instances, the addition of the application to the sub-user interface may include adding a link (e.g., URL or URI) to an application database 118 of the back-end server 110 to access the application from a third-party system 150, such as an application serving system and/or an application hosting system. In other implementations, the addition of the application may include downloading and/or otherwise adding application data for the application to the application database 118. In some implementations, each application may be associated with an application profile data structure. The application profile data structure may include tags and/or goals and/or sub-goals that the corresponding application is designed and/or intended to reinforce or teach to a user of the application. The user of an administrator device 120 and/or teacher device 140 can add, remove, or modify the data of the application profile data structure. For instance, the application profile data structure can be a data file with one or more values and/or ranges corresponding to preferred development scores for a user of the application. In some implementations, the application profile data structure may be a vector of values for corresponding development scores for a student for which the application is intended to be used. In some instances, the application profile data structure may also include a flag or other indicator to identify the application as a recommended application (e.g., if a teacher or administrator desires to emphasize certain applications).

As described in greater detail herein, the application profile data structure is used to select, filter, and/or rank applications based on development scores for students, thereby tailoring suggested applications based on a current educational status of a student. An application relevance score may be generated based on a comparison of one or more development scores for one or more educational goals, sub-goals, and/or one or more tags for a student to the vector of values for corresponding development scores for a student for which the application is intended to be used. In some implementations, the application relevance score is generated based on an error calculation between one or more of the development scores and the data of the application profile data structure to get a total difference between the one or more development scores of the student and the development scores of the application.

An icon may also be added to populate the user interface 2900. In some implementations, selection of an icon associated with a link by a user of a device, such as a parent device 130 and/or any other device, redirects the device to the location of an application installation file to download the application from an application serving system and/or to an application executable file to access of an application hosting system. Such a system may thus improve the function of the device by reducing the data transmitted to search for the corresponding application by directly linking the device to the location for downloading the application and/or accessing the application, such as linking the device to the corresponding third-party system 150. That is, the user interface 2900 with the icons can serve as a central repository or marketplace for accessing applications relevant to the goal and/or sub-goal and/or tags, thereby reducing internet network traffic.

In some implementations, selection of an icon associated with application data stored in the application database 118 by a user of the device may cause the device to request the application from the back-end server 110 and/or to execute the application remotely from the back-end server 110 (e.g., a hosted application). Such a system may thus improve the function of the device by reducing the data transmitted to search for the corresponding application by directly providing the device with the application data and/or transmitting only the data needed to execute the application remotely. That is, the user interface 2900 with the icons can serve as a central repository or marketplace for accessing applications relevant to the goal and/or sub-goal and/or tags, thereby reducing internet network traffic and/or storage space requirements for the device that accesses and uses the applications.

In still further implementations, selection of an icon of the user interface 2900 may initially cause the device to check if the application is installed on the device, such as by querying an installed application list of the device for an identifier associated with the application. If the application is installed on the device, the device may then execute or launch the application on the device.

In some implementations, a user of the administrator device 120 or teacher device 140 may include a description and/or activity to be performed when utilizing the application. For instance, an application utilized by a teacher for developing and/or accomplishing one or more goals and/or sub-goals of the curriculum may include a particular activity, level, game, etc. to do with the student or child when using the application. Thus, teachers, schools, etc. that may currently utilize applications as part of their curriculum and/or to reinforce the concepts of the goals and/or sub-goals may integrate such applications into an easy to use and subject/goal-linked interface for directly accessing and utilizing such applications. In some implementations, the description and/or activity to be performed when utilizing the application may be included in a pop-up or other informational notice to the user.

The interfaces 2600, 2700, 2800, 2900 of FIGS. 26-29 demonstrating aspects of the system may also be presented to a user of a parent device 130 without the ability to modify the data of the back-end server 110. For instance, a user of the parent device 130 may access and view the curriculum of curriculum data stored on the back-end server 110 via the interface 2600 of FIG. 26 demonstrating aspects of the system. A user of the parent device 130 may access the sub-user interface 2700 shown in FIG. 27 demonstrating aspects of the system for selecting a selection icon or other selection feature corresponding to a subject of a curriculum defined in the curriculum data for the student or child associated with the parent device, such as subjects corresponding to Common Core State Standards, the Head Start Child Development, Early Learning Framework, state-specific curriculum subjects, and/or any other curriculum subjects.

Responsive to a selection of an icon corresponding to a subject of the curriculum, a user of the parent device 130 is presented with the sub-user interface 2800 shown in FIG. 28 demonstrating aspects of the system having icons or other selection features for selecting a goal and/or sub-goal for the selected subject, such as goals and/or sub-goals corresponding to Common Core State Standards, the Head Start Child Development, Early Learning Framework, state-specific curriculum goals and/or sub-goals, and/or any other curriculum goals and/or sub-goals.

Responsive to a selection of an icon corresponding to a selected goal and/or sub-goal for the selected subject, a user of the parent device 130 is presented with the sub-user interface 2900 shown in FIG. 29 demonstrating aspects of the system for selecting an icon or other selection feature corresponding to an application associated with the goal and/or sub-goal for the selected subject. Responsive to the selection of an icon or other selection feature of the one or more selectable icons or other selection features, the parent device 130 may be directly linked to a third-party application store landing page for the installation file of the application of an application serving system and/or application hosting system for accessing and/or downloading the application. In other instances, the selection of the icon or other selection feature of the one or more selectable icons or other selection features may result in the parent device 130 requesting the application from the back-end server 110 and/or to execute the application remotely from the back-end server 110. In some implementations, the back-end system 110 may also transmit data relevant for the application to the parent device 130 (e.g., a student or child's name, educational level, a goal and/or sub-goal to be achieved, etc.) such that a seamless transfer of data may occur without the need for manual import/export systems to prepare the application for usage. Such automatic exportation/importation of the relevant data may be performed by one or more application programming interfaces (APIs) of the back-end system 110 and/or application. The presentation of applications based on subject, goal, and/or sub-goal thus provides context when provided to users in fewer steps and alongside tools used to manage processes for which those applications would be most relevant rather than separately retrieving the applications from an application serving system and/or application hosting system.

In some implementations, usage and/or scoring data may be transmitted to the back-end server 110 as the application is utilized by a user of the parent device 130 to log usage statistics and/or scoring statistics. Thus, the parent engagement and learning management system may also be utilized to monitor parental involvement and/or reinforcement of the student or child when the student or child is away from the educational facility.

In some further implementations, similar categorical applications and/or applications associated with similar subject, goals, and/or sub-goals may be suggested to a user of the parent device 130, thereby extending the applications utilized beyond a selected application and furthering the reinforcement of educational goals and/or sub-goals of a curriculum. For instance, FIG. 30 depicts a process 3000 for recommending additional content to reinforce educational development. The process 3000 includes accessing a plurality of images (block 3002). The plurality of images may be stored in the record database 112 of the back-end server 110 and may include metadata indicating one or more tags associated with each image. In some implementations, the metadata may be separately stored from the images. The accessing of the plurality of images may be based on an identifier for a particular goal or sub-goal, a particular tag, a particular day, a particular class or group, a particular student or child, aggregated goals or sub-goals, aggregated classes or groups, the entirety of a school or other educational facility, etc.

The process 3000 also includes aggregating a number of tags for the plurality of images (block 3004). The back-end system 110 and/or the data analytics system 116 can calculate a total number of tags of each type for the plurality of accessed images. That is, if images A, B, and C are accessed for student 1, and image A has tags science, listening, and writing, image B has tags listening and writing, and image C has the tag writing, then the data analytics system 116 and/or back-end system 110 can calculate the number of science tags as one, the number of listening tags as two, and the number of writing tags as three. Thus, the aggregated number of tags for each tag is determined by the back-end system 110 and/or data analytics system 116. In some implementations, the data analytics system 116 and/or back-end system 110 can directly access the tags without accessing the images.

The process 3000 further includes generating a development score based on the aggregated number of tags and a predetermined threshold (block 3006). For instance, using the foregoing aggregated number of tags of one for science, two for listening, and three for writing, the data analytics system 116 and/or back-end system 110 can generate a development score using a predetermined threshold. If the predetermined threshold is ten (i.e., corresponding to having an educational goal of ten events and/or experiences), then the development score can be calculated as 10% for the science tag, 20% for the listening tag, and 30% for the writing tag based on the aggregated tags and the predetermined threshold of ten using a linear algorithm. In some implementations, the predetermined threshold may be based on a curriculum for the student, class, school, etc. In other implementations, more complex algorithms for the development score may be implemented (e.g., having the development score be based on a weighted value for the aggregated tags, having the development score be based on a multi-variable weighted function of several aggregated tags, etc.). In some implementations, an aggregate development score may be calculated from one or more development scores and/or directly from aggregated numbers of tags and the predetermined threshold values.

The process 3000 also includes comparing the development score to an application profile data structure (block 3008). The application profile data structure can be a data file with one or more values and/or ranges corresponding to preferred development scores for a user of a corresponding application. In some implementations, the application profile data structure may be a vector of values for corresponding development scores for a student for which the application is intended to be used. An application relevance score is generated based on a comparison of the development score for one or more educational goals, sub-goals, and/or one or more tags for a student to the values of the application profile data structure (block 3010). In some implementations, the application relevance score is generated based on an error calculation between one or more of the development scores and the data of the application profile data structure. That is, if a current student profile has development scores of 10% for the science tag (or 0.1), 20% for the listening tag (or 0.2), and 30% for the writing tag (or 0.3), and an example application profile data structure for an application has values of 15% for science, 15% for listening, and 20% for writing, then an application relevance score can be calculated based on the differences between the current student profile and the values of the application profile data structure. In some implementations, the different values may be weighted differently depending on the characteristics of the application (e.g., if the application is irrelevant to a corresponding tag, the weight can be zero).

In some implementations, a recommendation value of the application profile data structure may be used to modify the application relevance score. The application profile data structure may include a flag or other indicator to identify the application as a recommended application (e.g., if a teacher or administrator desires to emphasize certain applications). If the application profile data structure includes the flag or other indicator, then the generated application relevance score may be increased by a predetermined value and/or multiplier.

The process 3000 also includes selecting an application identifier of an application based on the application relevance score (block 3012). In some implementations, the application identifier associated with the highest application relevance score may be selected. In some implementations, the selection of an application identifier may include comparing the application relevance score to an application score threshold value and selecting the application identifier responsive to the application relevance score exceeding the application score threshold value. That is, low relevance applications may be filtered out prior to a selection of an application identifier and/or prior to a ranking of applications.

The application identifier for the application can then be transmitted to a client device, such as a parent device 130, to link or redirect to the application (block 3014). In some implementations, the client device is redirected to an installation file for the application responsive to a selection of a displayed icon for the application identifier. As noted above, the client device may be redirected to a third-party application store landing page for the installation file. In other instances, the client device may be redirected to an installed application on the client device responsive to a selection of a displayed icon for the application identifier.

In some implementations, the process 3000 may be initiated upon receiving a request for recommended applications from an interface displayed on the client device. For instance, interfaces 2600, 2700, 2800, 2900 may include a selection feature to display one or more recommended applications. Selection of such a feature sends a request to the back-end server 110 to initiate the process 3000 and transmitting the application identifier for the application is responsive to the request.

In some implementations, several application relevance scores may be generated for several applications and the applications may be ranked based on each application's application relevance score. A ranked order for the application s can be transmitted to the client device for display in an interface displayed on a display of the client device. The ranked order may be a data file with a sequential listing of the ranked application identifiers. A listing of recommended applications can then be presented in an interface of the device.

In some further implementations, the aggregated tags may be used to generate a progress report based on the development scores. For instance, a first plurality of images associated with a first tag and a second plurality of images associated with a second tag may be accessed in a similar manner to block 3002 of process 3000. A first number of first tags for the first plurality of images and a second number of second tags for a second plurality of images may be aggregated in a similar manner to block 3004. Development scores based on the aggregated number of tags and corresponding predetermined threshold may be generated and used to generate a progress report based on the development scores, such as a progress report shown in interfaces 1900, 2000, 2100, 2200. The progress report and/or display data to display the progress report can then be transmitted to a client device to be displayed in an interface.

Thus, the system can use tags from pictures and/or entries as a proxy for educational development. Such a system permits parents to obtain up-to-date progress reports for their children and/or to assist in reinforcement or further development at home based on the current development profile for the child. The system includes application recommendations and directly links a parent to the recommended applications such that separate searching and selection is eliminated. Moreover, in some implementations, by providing the application and/or accessing the application through the interface, the school and/or teacher may obtain data indicative of whether and/or how often a parent or student is assisting in the educational development at home.

In some implementations, the user interfaces described herein may be mobile user interfaces adapted to be displayed on a display of a mobile device.

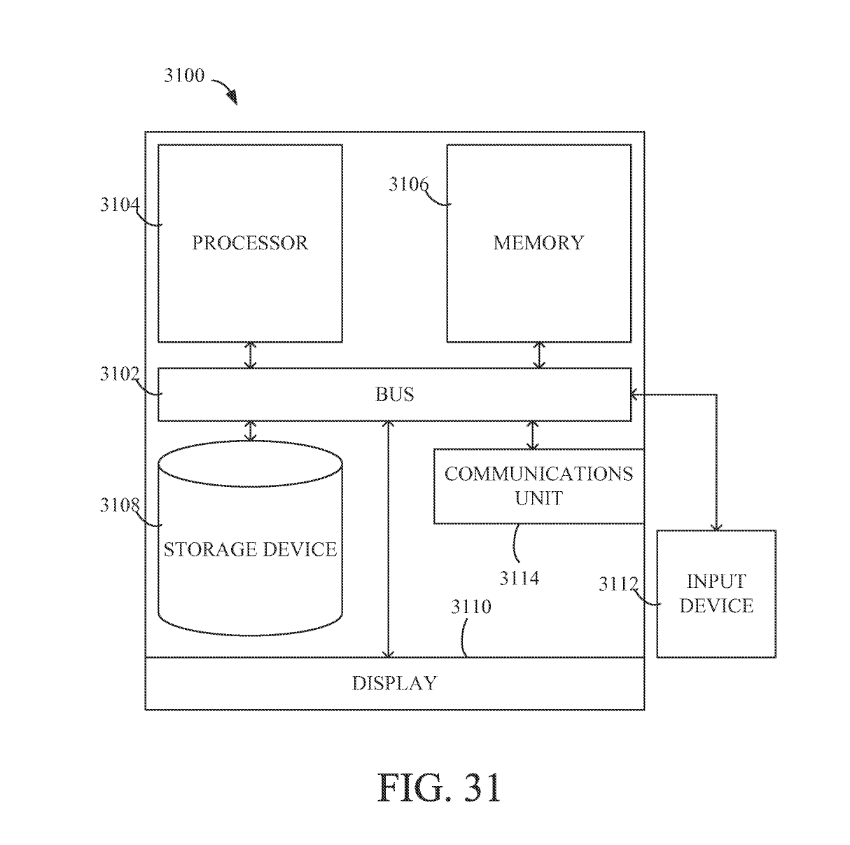

FIG. 31 is a block diagram of a computer system 3100 for the back-end server 110, the one or more administrator devices 120, the one or more parent devices 130, the one or more teacher devices 140, and/or the one or more third-party systems 150. The computer system 3100 can be used to implement one or more of the processes described herein by the back-end server 110, the one or more administrator devices 120, the one or more parent devices 130, the one or more teacher devices 140, and/or the one or more third-party systems 150. The processes may be implemented via instructions in code from any suitable computer programming language such as, but not limited to, C, C++, C#, Java®, JavaScript®, Perl®, HTML, XML, Python®, and/or Visual Basic®. The computing system 3100 includes a bus 3102 or other communication component for communicating information and a processor 3104 coupled to the bus 3102 for processing information. The computing system 3100 can also include one or more processors 3104 coupled to the bus 3102 for processing information. The computing system 3100 also includes memory 3106, such as a RAM or other dynamic storage device, coupled to the bus 3102 for storing information, and instructions to be executed by the processor 3104. The memory 3106 can also be used for storing position information, temporary variables, or other intermediate information during execution of instructions by the processor 3104. The computing system 3100 may further include a storage device 3108 or other static storage device coupled to the bus 3102 for storing static information and instructions for the processor 3104. In some implementations, the storage device 3108 may be a solid state device, magnetic disk or optical disk, is coupled to the bus 3102 for persistently storing information and instructions. The computing device 3100 may include, but is not limited to, digital computers, such as laptops, desktops, workstations, personal digital assistants, servers, blade servers, mainframes, cellular telephones, smart phones, mobile computing devices (e.g., a notepad, e-reader, etc.) etc.

The computing system 3100 may be coupled via the bus 3102 to a display 3110, such as a Liquid Crystal Display (LCD), Thin-Film-Transistor LCD (TFT), an Organic Light Emitting Diode (OLED) display, LED display, Electronic Paper display, Plasma Display Panel (PDP), and/or other display, etc., for displaying information to a user. An input device 3112, such as a keyboard including alphanumeric and other keys, may be coupled to the bus 3102 for communicating information and command selections to the processor 3104. In another implementation, the input device 3112 may be integrated with the display 3110, such as in a touch screen display. The input device 3112 can include a cursor control, such as a mouse, a trackball, or cursor direction keys, for communicating direction information and command selections to the processor 3104 and for controlling cursor movement on the display 3110.

According to various implementations, the processes and/or methods described herein can be implemented by the computing system 3100 in response to the processor 3104 executing an arrangement of instructions contained in memory 3106. Such instructions can be read into the memory 3104 from another computer-readable medium, such as the storage device 3108. Execution of the arrangement of instructions contained in the memory 3104 causes the computing system 3100 to perform the illustrative processes and/or method steps described herein. One or more processors 3104 in a multi-processing arrangement may also be employed to execute the instructions contained in the memory 3104. In alternative implementations, hardwired circuitry may be used in place of or in combination with software instructions to effect illustrative implementations. Thus, implementations are not limited to any specific combination of hardware circuitry and software.

The computing system 3100 also includes a communications unit 3114 that may be coupled to the bus 3102 for providing a communication link between the system 3100 and a network. As such, the communications unit 3114 enables the processor 3104 to communicate, wired or wirelessly, with other electronic systems coupled to the network. For instance, the communications unit 3114 may be coupled to an Ethernet line that connects the system 3100 to the Internet or another network. In other implementations, the communications unit 3114 may be coupled to an antenna (not shown) and provides functionality to transmit and receive information over a wireless communication interface with the network.

In various implementations, the communications unit 3114 may include one or more transceivers configured to perform data communications in accordance with one or more communications protocols such as, but not limited to, WLAN protocols (e.g., IEEE 802.11 a/b/g/n/ac/ad, IEEE 802.16, IEEE 802.20, etc.), PAN protocols, Low-Rate Wireless PAN protocols (e.g., ZigBee, IEEE 802.15.4-2003), Infrared protocols, Bluetooth protocols, EMI protocols including passive or active RFID protocols, and/or the like.

The communications unit 3114 may include one or more transceivers configured to communicate using different types of protocols, communication ranges, operating power requirements, RF sub-bands, information types (e.g., voice or data), use scenarios, applications, and/or the like. In various implementations, the communications unit 3114 may comprise one or more transceivers configured to support communication with local devices using any number or combination of communication standards.

In various implementations, the communications unit 3114 can also exchange voice and data signals with devices using any number or combination of communication standards (e.g., GSM, CDMA, TDNM, WCDMA, OFDM, GPRS, EV-DO, WiFi, WiMAX, S02.xx, UWB, LTE, satellite, etc). The techniques described herein can be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. A CDMA network can implement a radio technology such as Universal Terrestrial Radio Access (UTRA), cdma2000, etc. UTRA includes Wideband-CDMA (W-CDMA) and Low Chip Rate (LCR). CDMA2000 covers IS-2000, IS-95, and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS, and LTE are described in documents from an organization named “3rd Generation Partnership Project” (3GPP). CDMA2000 is described in documents from an organization named “3rd Generation Partnership Project 2” (3GPP2).

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

As noted above, implementations within the scope of this disclosure include program products comprising non-transitory machine-readable media for carrying or having machine-executable instructions or data structures stored thereon. Such machine-readable media can be any available media that can be accessed by a general purpose or special purpose computer or other machine with a processor. By way of example, such machine-readable or non-transitory storage media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Implementations have been described in the general context of method steps which may be implemented in one implementation by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of executable instructions or associated data structures represents examples of corresponding acts for implementing the functions described in such steps.

As previously indicated, implementations may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Implementations may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative implementations. Accordingly, all such modifications are intended to be included within the scope of the present disclosure as defined in the appended claims. Such variations will depend on the software and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

It is important to note that the construction and arrangement of the system shown in the various exemplary implementations is illustrative only and not restrictive in character. All changes and modifications that come within the spirit and/or scope of the described implementations are desired to be protected. It should be understood that some features may not be necessary and implementations lacking the various features may be contemplated as within the scope of the application, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

The foregoing description of implementations has been presented for purposes of illustration and description. It is not intended to be exhaustive or to limit the disclosure to the precise form disclosed, and modifications and variations are possible in light of the above teachings or may be acquired from this disclosure. The implementations were chosen and described in order to explain the principals of the disclosure and its practical application to enable one skilled in the art to utilize the various implementations and with various modifications as are suited to the particular use contemplated. Other substitutions, modifications, changes and omissions may be made in the design, operating conditions and arrangement of the implementations without departing from the scope of the present disclosure as expressed in the appended claims.

What is claimed is:

1. A method of recommending additional content to reinforce educational development, comprising:
accessing, by one or more data processors, a plurality of images, each of the plurality of images associated with a tag;
aggregating, using one or more data processors, a number of tags for the plurality of images;
generating, using one or more data processors, a development score using the aggregated number of tags and a predetermined threshold;
comparing, using one or more data processors, the development score to an application profile data structure of an application;
generating, using one or more data processors, an application relevance score based on the comparison of the development score to the application profile data structure;
selecting, using one or more data processors, an application identifier of the application based on the application relevance score; and
transmitting the application identifier for the application to a client device to link to the application.

2. The method of claim 1, wherein the client device is redirected to an installation file for the application responsive to a selection of a displayed icon for the application identifier, wherein the application is an early education application and wherein the development score is a development score for an early education goal.

3. The method of claim 2, wherein the client device is redirected to a third-party application store landing page for the installation file.

4. The method of claim 1, wherein the client device is redirected to an installed application on the client device responsive to a selection of a displayed icon for the application identifier, wherein the application is an early education application and wherein the development score is a development score for an early education goal.

5. The method of claim 1 comprising:
generating the application relevance score based on a recommendation value.

6. The method of claim 1, wherein selecting the application identifier of the application based on the application relevance score comprises:
comparing, using one or more data processors, the application relevance score to an application score threshold value; and
selecting the application identifier responsive to the application relevance score exceeding the application score threshold value.

7. The method of claim 1, further comprising:
receiving a request for recommended applications from an interface displayed on the client device;
wherein transmitting the application identifier for the application is responsive to the request for recommended applications; and
wherein the client device displays an interface with an icon for the application based on the transmitted application identifier, the icon redirecting the client device to link to the application upon selection.

8. A system, comprising:
one or more processors; and one or more storage devices storing instructions that, when executed by the one or more processors, cause the one or more processors to perform operations comprising:
accessing a first plurality of images associated with a first tag and a second plurality of images associated with a second tag;
aggregating a first number of first tags for the first plurality of images and a second number of second tags for the second plurality of images;
generating a first development score using the aggregated first number of first tags and a first predetermined threshold;
generating a second development score using the aggregated second number of second tags and a second predetermined threshold;
generating a progress report based on the first development score and the second development score; and
transmitting the progress report to a client device to be displayed in an interface.

9. The system of claim 8, wherein the first tag and second tag are based on an educational goal.

10. The system of claim 8, wherein the progress report comprises a graphical chart.

11. The system of claim 8, wherein the first predetermined threshold and second predetermined threshold are based on an educational curriculum.

12. The system of claim 8, wherein generating the first development score is based on a linear algorithm for the first predetermined threshold.

13. The system of claim 8, wherein the one or more storage devices stores instructions that, when executed by the one or more processors, cause the one or more processors to perform operations further comprising:
receiving an image associated with the first tag of the first plurality of images from a second client device, wherein the client device is a parent device and the second client device is an educator device.

14. The system of claim 8, wherein the one or more storage devices stores instructions that, when executed by the one or more processors, cause the one or more processors to perform operations further comprising:
generating an aggregate development score based on the aggregated first number of first tags, the first predetermined threshold, the aggregated second number of second tags, and a second predetermined threshold.

15. A computer readable storage device storing instructions that, when executed by one or more processors, cause the one or more processors to perform operations comprising:
accessing a plurality of aggregated tags, each of the plurality of tags associated with an educational development category;
generating a plurality of development scores using the plurality of aggregated tags and a plurality of predetermined thresholds;
comparing the plurality of development scores to a first application profile data structure of a first application;
generating a first application relevance score based on the comparison of the plurality of development scores to the first application profile data structure;
comparing the plurality of development scores to a second application profile data structure of a second application;
generating a second application relevance score based on the comparison of the plurality of development scores to the second application profile data structure;
ranking the first application and the second application based on the first application relevance score and the second application relevance score; and
transmitting data indicative of a ranked order for the first application and the second application to a client device for display in an interface displayed on a display of the client device.

16. The computer readable storage device of claim 15, wherein the transmitted data indicative of the ranked order comprises a first application identifier for the first application and a second application identifier for the second application.

17. The computer readable storage device of claim 16, wherein the client device is redirected to an installation file for the first application responsive to a selection of a displayed icon for the first application identifier, wherein the first application is an early education application and wherein the plurality of development scores are development scores for early education goals.

18. The computer readable storage device of claim 17, wherein the client device is redirected to a third-party application store landing page for the installation file.

19. The computer readable storage device of claim 15, wherein the client device is redirected to an installed application on the client device responsive to a selection of a displayed icon for the first application identifier, wherein the first application is an early education application and wherein the plurality of development scores are development scores for early education goals.

20. The computer readable storage device of claim 15 comprising:
generating the first application relevance score based on a recommendation value.
